(19) United States
(12) Patent Application Publication
(10) Pub. No.: US 2025/0062390 A1
(43) Pub. Date: Feb. 20, 2025

(54) STACK, ELECTRODE STRUCTURE, BATTERY, FLIGHT VEHICLE, METHOD FOR PRODUCING STACK, AND METHOD FOR PRODUCING ELECTRODE STRUCTURE

(71) Applicant: SoftBank Corp., Tokyo (JP)

(72) Inventors: Shuntaro MIYAKAWA, Tokyo (JP); Takaya SAITO, Tokyo (JP); Yoshiki TAKAYANAGI, Tokyo (JP)

(21) Appl. No.: 18/938,284

(22) Filed: Nov. 6, 2024

Related U.S. Application Data
(63) Continuation of application No. PCT/JP2023/022886, filed on Jun. 21, 2023.

(30) Foreign Application Priority Data
Jun. 21, 2022 (JP) 2022-099624

(51) Int. Cl. H01M 10/04; H01M 4/02; H01M 50/414; H01M 50/536

(52) U.S. Cl. CPC H01M 10/0468; H01M 4/02; H01M 50/414; H01M 50/536; H01M 2004/021; H01M 2220/20

(57) ABSTRACT

A stack including a plurality of stacked sheet materials is provided. Each of the plurality of sheet materials has a support layer including a resin material and a first metal layer and a second metal layer formed on both faces of the support layer. In a part of the plurality of sheet materials, the plurality of first metal layers and the plurality of second metal layers included in the plurality of sheet materials are integrated.

The contents of the following patent application(s) are incorporated herein by reference:
NO. 2022-099624 filed in JP on Jun. 21, 2022
NO. PCT/JP2023/022886 filed in WO on Jun. 21, 2023

### BACKGROUND

### 1. Technical Field

The present invention relates to a stack, an electrode structure, a battery, a flight vehicle, a method for producing the stack, and a method for producing the electrode structure.

### 2. Related Art

Patent Document 1 discloses a welding method for welding a semi-insulator having a chemical conversion coating and a metallic conductor. Patent Document 2 discloses a welding method for welding a first metal material and a second metal material of an electronic component in which a resin insulating plate is sandwiched between the first metal material and the second metal material on both faces. Patent Document 3 discloses a current collector in which electrically conductive layers are formed on both faces of a support layer and the inside of the through-hole extending through the support layer and the electrically conductive layer is filled with electrically conductive material.

### PRIOR ART DOCUMENT

### Patent Document

(Patent document 1) Japanese Patent Application Publication No. 2004-130331
(Patent document 2) Japanese Patent Application Publication No. 2006-305591
(Patent document 3) Japanese Patent Application Publication No. 2019-186204

### BRIEF DESCRIPTION OF THE DRAWINGS

FIG. 1 schematically illustrates one example of a system configuration of a flight vehicle 100.

FIG. 2 schematically illustrates one example of a power storage cell 112.

FIG. 3 schematically illustrates another example of the power storage cell 112.

FIG. 4 schematically illustrates one example of a current collector 400.

FIG. 5 schematically illustrates one example of a current collector 500.

FIG. 6 schematically illustrates one example of a current collector 600.

FIG. 7 schematically illustrates one example of a stack structure 760.

FIG. 8 schematically illustrates one example of an electrical connection relationship between the electrodes of the stack structure 760.

FIG. 9 schematically illustrates one example of a producing method of the power storage cell 112.

FIG. 10 schematically illustrates one example of a producing method of a positive electrode 220.

FIG. 11 illustrates one example of a welding procedure using a welding device 1120.

FIG. 12 illustrates one example of a plurality of through-holes 620 arranged in a current collector 1102.

FIG. 13 illustrates one example of the plurality of through-holes 620 arranged in the current collector 1102.

FIG. 14 illustrates one example of a procedure for fabricating the stack structure 760.

FIG. 15 schematically illustrates one example of a cross-section of an integrated region of a positive electrode connection 820.

FIG. 16 illustrates one example of an SEM image of the cross-section of the integrated region in Example 1.

### DESCRIPTION OF EXEMPLARY EMBODIMENTS

According to one embodiment exemplified in the present specification (sometimes referred to as the present embodiment), the stack is fabricated by welding a part of a plurality of welding targets stacked together. Each of the above-described plurality of welding targets includes a support layer including resin material and a first metal layer and a second metal layer formed on both faces of the support layer. The above-described welding target may be sheet-shaped material (sometimes referred to as sheet material). The above-described welding target may be a current collector used for an electrode of a battery.

The first metal layer and the second metal layer of each of the above-described plurality of welding targets are electrically connected. In this way, the first metal layer and the second metal layer may be welded via resistance welding, for example.

The type of the above-described resin material is not particularly limited but any thermoplastic resin material may be used as the resin material. The support layer may be substantially constituted of thermoplastic resin material and the support layer may be the thermoplastic resin material.

By using the thermoplastic resin material as a main component of the support layer, for example, the safety of the battery improves when the stack is used as an electrode of a battery. More specifically, when the above-described battery has a thermal runaway, the thermoplastic resin material melts due to the heat. As a result, the thermal runaway may stop.

In addition, thermoplastic resin material softens and increases its fluidity when the temperature of the resin material rises. In this way, in the welding process of a plurality of welding targets, when pressure is applied to the heated welding targets, the resin material arranged between the first metal layer and the second metal layer easily moves and the first metal layer and the second metal layer come close to or come into contact with each other. In this state, when energy is applied to the first metal layer and the second metal layer, the first metal layer and the second metal layer are integrated.

In the case where the first metal layer and the second metal layer are welded, when pressure is applied to the first metal layer and the second metal layer and the first metal layer and the second metal layer come close to or come into contact with each other, the support layer arranged between the first metal layer and the second metal layer is extruded to the surroundings of the welded point. As a result, the volume of the surroundings of the welded point expands, compromising its smoothness. As the number of the welding targets to be stacked increases, the effect of the above-described volume expansion increases.

In contrast, according to one example of the present embodiment, the support layer includes thermoplastic resin material and a plurality of through-holes, extending through the support layer, the first metal layer and the second metal layer, are formed in a part of each of the above-described plurality of welding targets. In addition, at least a part of the region in which the above-described through-hole is formed is welded. In this way, the volume expansion of the surroundings of the welded point is suppressed.

According to one example of the present embodiment, a plurality of welding targets are welded by the procedure described below. At first, energy is applied to the softened region arranged in a part of the plurality of welding targets. As described above, the support layer of the welding target in the present embodiment mainly includes, for example, thermoplastic resin material. When appropriate energy is applied to the softened region of the welding target, the temperature of the thermoplastic resin material included in the support layer rises and the resin material softens.

Then, a welded region arranged in at least a part of the softened region of the welding target is pressed. In this way, pressure is applied to the resin material of the support layer arranged between the first metal layer and the second metal layer. The resin material existing inside the welded region softens and has a moderate fluidity. Therefore, when an appropriate magnitude of pressure is applied to the resin material of the support layer, the resin material moves inside the welding target.

As described above, the plurality of through-holes, extending through the support layer, the first metal layer, and the second metal layer, are formed in the welded region of the welding target in the present embodiment. Therefore, compared to the case where no through-hole is formed in the welded region, the amount of the resin material causing the above-described volume expansion is smaller. In addition, according to the present embodiment, the resin material existing inside the welded region flows into the through-hole existing in the surroundings of the welded region. In addition, a part of the resin material existing inside the welded region flows into the through-hole formed in the first metal layer and the second metal layer existing inside the welded region.

When the welded region of the welding target is pressed and the first metal layer and the second metal layer come close to or come into contact with each other, current and/or voltage are applied to the welded region of the welding target. In this way, the first metal layer and the second metal layer of each of the plurality of welding targets are welded. In addition, the first metal layer and the second metal layer of the adjacent welding target are welded.

As described above, according to the present embodiment, the amount of the resin material extruded from the welded region due to the welding is small. In addition, the resin material extruded due to the welding flows into the through-hole. In this way, according to the present embodiment, compared to the case where no through-hole is formed in the welded region, the above-described volume expansion is significantly suppressed.

As described above, the above-described welding target is, for example, a current collector used for an electrode of a battery, and the method for producing the above-described stack or the method for welding the plurality of stacked welding targets may be applied to the fabrication of the electrode structure arranged inside the housing of the battery (particularly. a secondary battery). According to the present embodiment, because the through-holes are formed in a part of the current collector, the apparent density of the current collector is low. In addition, the density of the resin material may be lower than the density of the metal material constituting the first metal layer and the second metal layer. in this way, according to the present embodiment, compared to the conventional power storage cell, the energy density per unit mass of the power storage cell [Wh/kg-power storage cell] and/or the capacity per unit mass of the active material [mAh/g-active material] may improve.

For example, aluminum foil, copper foil, or the like having a thickness of approximately 8 to 20 μm are conventionally used as the current collector. Therefore, in the conventional battery, the ratio of the mass of the current collector of the positive electrode and the negative electrode to the mass of the power storage cell is from 20 to 25%. In contrast, according to the present embodiment, a part of the current collector is formed of a substance (typically, air or resin material) with a density lower than that of aluminum foil or copper foil. As a result, a power storage cell with excellent energy density per unit mass and/or capacity per unit mass of the active material may be provided. For example, according to the present embodiment, a power storage cell with an energy density per unit mass of 350 [Wh/kg-power storage cell] or more may be provided. In addition, a battery including the power storage cell according to the present embodiment is particularly suitable for an application of a flight vehicle because it has a high energy density per unit mass.

As described above, according to the present embodiment, for example, the energy amount per weight in a rechargeable battery can be improved and a rechargeable battery that is lighter and can accumulate more electrical power can be achieved. For example, the rechargeable battery may be brought to a disaster site and used for energy supply to victims or the like. Therefore, the stack, the electrode structure, and the battery according to the present embodiment as well as the producing method thereof can contribute to achieving goal 7 “clean energy for everyone”, goal 13 “concrete action for climate change”, or the like of the Sustainable Development Goals (SDGs).

Hereinafter, the present invention will be described through embodiments of the invention, but the following embodiments do not limit the invention according to the claims. In addition, not all of the combinations of features described in the embodiments are imperative to the solutions of the invention.

In the present specification, when a numerical range is expressed as “from A to B”, the expression means A or more and B or less. In addition, “substituted or unsubstituted” means “substituted with any substituent, or not substituted with a substituent”. A type of substituent described above is not particularly limited unless otherwise stated in the specification. In addition, the number of substituents described above is not particularly limited unless otherwise stated in the specification.

### (The Overview of the Flight Vehicle 100)

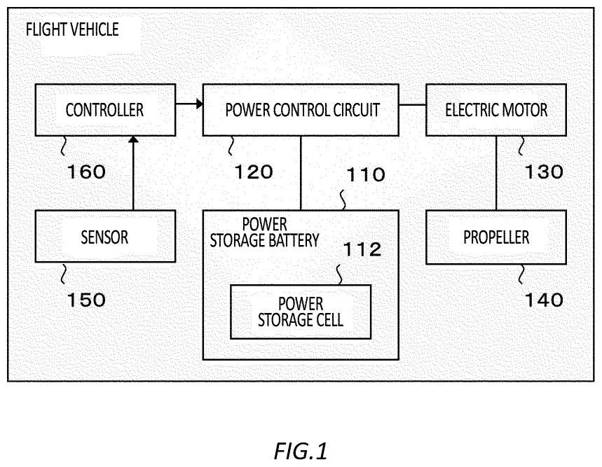

FIG. 1 schematically illustrates one example of the system configuration of the flight vehicle 100. In the present embodiment, the flight vehicle 100 includes a power storage battery 110, a power control circuit 120, one or more electric motors 130, one or more propellers 140, one or more sensors 150, and a controller 160. In the present embodiment, the power storage battery 110 has one or more power storage cells 112.

In the present embodiment, the flight vehicle 100 flies by using the electrical energy accumulated in the power storage battery 110. Examples of the flight vehicle include an airplane 100, an airship or a balloon, a hot-air balloon, a helicopter, a drone, or the like.

In the present embodiment, the power storage battery 110 receives electrical energy from an external charging device (not shown in the figure) via the power control circuit 120 and accumulates the electrical energy in the one or more power storage cells 112. In addition, the power storage battery 110 supplies the electrical energy accumulated in the one or more power storage cell 112 to the electric motor 130 via the power control circuit 120.

In the present embodiment, the power storage cell 112 accumulates electrical energy, which is sometimes referred to as the charging of the power storage cell 112. In addition, the power storage cell 112 releases the accumulated electrical energy, which is sometimes referred to as the discharging of the power storage cell 112. The power storage cell 112 may be a secondary battery.

The power storage cell 112 may be a solid-state battery. The power storage cell 112 may be a solid-state secondary battery. The solid-state secondary battery is the secondary battery that substantially does not include the above-described electrolytic solution or gel electrolyte but includes, for example, a pair of electrodes and a solid electrolyte layer arranged between the pair of electrodes.

The secondary battery substantially not including the electrolytic solution or the gel electrolyte means not only the secondary battery not including the electrolytic solution or the gel electrolyte but also the secondary battery including small amounts of the electrolytic solution or the gel electrolyte. This is because even if the constituent material of the secondary battery dissolves in the electrolytic solution or the solvent included in the gel electrolyte, the effect of the constituent material of the secondary battery dissolving in the solvent on the performance of the battery may be ignored as long as the amount of the solvent included in the secondary battery is small.

In one embodiment, the power storage cell 112 does not include at least one of (i) the electrolytic solution including supporting electrolyte salt and solvent or (ii) the gel electrolyte including supporting electrolyte salt, organic polymer compounds, and organic solvent. In another embodiment, the ratio of the mass of the electrolytic solution and the gel electrolyte [kg] to the mass of the organic compound used for active material [kg] is less than 5%.

Examples of the carrier ions of the secondary battery include lithium, sodium, potassium, magnesium, calcium, or the like. Examples of the secondary battery include a sodium ion secondary battery, a lithium ion secondary battery, a lithium metal secondary battery, a lithium air secondary battery, a lithium sulfur secondary battery, a magnesium ion secondary battery, or the like.

For example, a material that can accumulate a large charge amount per unit volume is often selected as the active material for the secondary battery to be mounted on the vehicle. On the other hand, in the present embodiment, the power storage cell 112 is mounted on the flight vehicle 100. Therefore, the active material used for the power storage cell 112 is preferably a material that can accumulate a large charge amount per unit mass.

The mass energy density of the power storage cell 112 is preferably 350 [Wh/kg-power storage cell] or more, more preferably 400 [Wh/kg-power storage cell] or more, more preferably 500 [Wh/kg-power storage cell] or more, more preferably 600 [Wh/kg-power storage cell] or more, and even more preferably 700 [Wh/kg-power storage cell] or more. In this way, the power storage cell particularly suitable for the application of the power supply for the flight vehicle can be obtained.

The volume energy density of the power storage cell 112 may be 300 [Wh/m³-power storage cell] or more and 1200 [Wh/m³-power storage cell] or less or may be 400 [Wh/m³-power storage cell] or more and 1000 [Wh/m³-power storage cell] or less. If the power storage cell 112 is mounted on the flight vehicle 100 as a part of the power supply of the flight vehicle 100, the volume energy density of the power storage cell 112 may be 600 [Wh/m³-power storage cell] or less or may be 800 [Wh/m³-power storage cell] or less.

The power storage cell 112 may have a mass energy density within the above-described numerical range and a volume energy density within the above-described numerical range. In this way, the power storage cell that is relatively difficult to use for the power supply of the vehicle can be used as the power supply of the flight vehicle. The details of the power storage cell 112 will be described below.

In the present embodiment, the power control circuit 120 controls the input and output of the electrical power of the power storage battery 110. The power control circuit 120 may control the input and output of the electrical power of the power storage battery 110 based on the instruction from the controller 160. For example, the power control circuit 120 includes a plurality of switching devices that operate based on the control signal from the controller 160.

In the present embodiment, the electric motor 130 receives the electrical energy from the power storage battery 110 via the power control circuit 120. The electric motor 130 uses the electrical energy received from the power storage battery 110 to rotate the propeller 140. In this way, the electric motor 130 can generate the propulsive force of the flight vehicle 100 using the electrical energy accumulated in the power storage cell 112.

In the present embodiment, the sensor 150 measures various physical quantities related to the position and posture of the flight vehicle 100. Examples of sensors for measuring the various physical quantities related to the position and posture of the flight vehicle 100 include a GPS signal receiver, an acceleration sensor, an angular acceleration sensor, a gyro sensor, or the like. The sensor 150 may measure various physical quantities related to the state of the power storage battery 110. Examples of a sensor for measuring various physical quantities related to the state of the power storage battery 110 include a temperature sensor, a current sensor, a voltage sensor, or the like.

In the present embodiment, the controller 160 controls the flight vehicle 100. The controller 160 may control the input and output of the electrical power of the power storage battery 110 by controlling the power control circuit 120. For example, the controller 160 controls the output current, the output voltage, the input current, the input voltage, or the like of the power storage battery 110. In this way, the controller 160 can control the position and posture of the flight vehicle 100. The controller 160 may control the position and posture of the flight vehicle 100 by controlling the power control circuit 120 based on the output from the sensor 150.

The power storage battery 110 may be one example of a secondary battery. The power storage cell 112 may be one example of a secondary battery. The electric motor 130 may be one example of a propulsive force generator. The secondary battery may be one example of a battery.

### (Overview of Power Storage Cell 112)

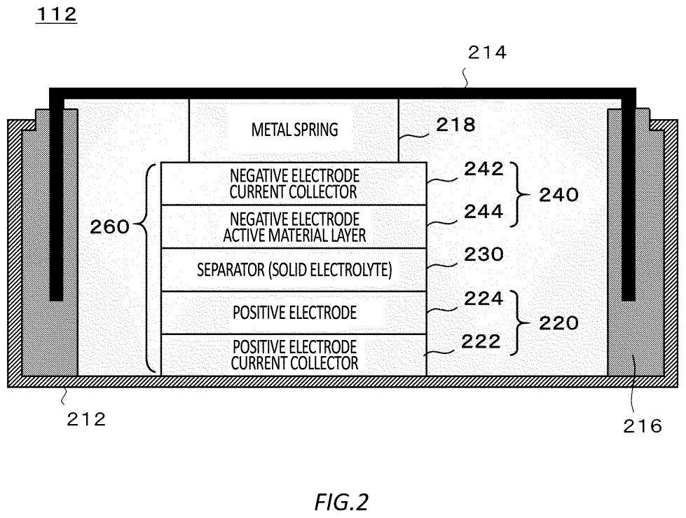

FIG. 2 schematically illustrates one example of the power storage cell 112. In the present embodiment, the detail of the power storage cell 112 is described by using an example in which the power storage cell 112 is a coin-shaped solid-state secondary battery. However, it is noted that the power storage cell 112 is not limited to the coin-shaped solid-state secondary battery.

### (Power Storage Cell)

In the present embodiment, the power storage cell 112 includes a positive electrode case 212, a negative electrode case 214, a sealant 216, and a metal spring 218. In addition, the power storage cell 112 includes a positive electrode 220, a separator 230, and a negative electrode 240. In the present embodiment, the positive electrode 220 has a positive electrode current collector 222 and a positive electrode active material layer 224. In the present embodiment, the negative electrode 240 has a negative electrode current collector 242 and a negative electrode active material layer 244.

In the present embodiment, the power storage cell 112 includes a structure 260 having a positive electrode 220, a separator 230, and a negative electrode 240. As illustrated in FIG. 2, the positive electrode 220, the separator 230, and the negative electrode 240 are stacked in this sequence and the separator 230 is arranged between the positive electrode 220 and the negative electrode 240.

In the present embodiment, the detail of the power storage cell 112 is described by using an example in which the power storage cell 112 substantially does not include the electrolytic solution or the gel electrolyte. In addition, in the present embodiment, the detail of the power storage cell 112 is described by using an example in which the positive electrode current collector 222 has (i) an electrically conductive layer including electrically conductive material and (ii) a support layer supporting the electrically conductive layer.

In the present embodiment, by assembling the positive electrode case 212 and the negative electrode case 214, spaces are formed inside the positive electrode case 212 and the negative electrode case 214. The metal spring 218, the positive electrode 220, the separator 230, and the negative electrode 240 are accommodated inside the space formed by the positive electrode case 212 and the negative electrode case 214. The positive electrode 220, the separator 230, and the negative electrode 240 are fixed, by a repulsive force of the metal spring 218, inside the positive electrode case 212 and the negative electrode case 214.

The positive electrode case 212 and the negative electrode case 214 are constituted of an electrically conductive material having, for example, a disc-like thin plate shape. In the present embodiment, the sealant 216 seals the gap formed between the positive electrode case 212 and the negative electrode case 214. The sealant 216 includes an insulating material. The sealant 216 insulates the positive electrode case 212 and the negative electrode case 214.

### (Positive Electrode)

In the present embodiment, the positive electrode current collector 222 retains the positive electrode active material layer 224. In the present embodiment, the positive electrode current collector 222 has an electrical resistance from 0.01 mΩ to 1Ω. In this way, before and after applying pressure to the electrically conductive layer (the detail of the electrically conductive layer is described below) of the positive electrode current collector 222 during the production of the positive electrode current collector 222, the variation in the voltage measured by applying current to the electrically conductive layer under a particular measurement condition is suppressed to, for example, less than 100 mV. The positive electrode current collector 222 may have an electrical resistance from 0.01 mΩ to 333 mΩ or may have an electrical resistance from 0.01 mΩ to 100 mΩ.

The density of the positive electrode current collector 222 is adjusted to, for example, approximately from 1.1 to 2.0 g/cm³. In this way, for example, if the main component of the active material included in the positive electrode active material layer 224 is anthraquinone (the density: 1.3 g/cm³), anthracene (the density: 1.25 g/cm³), and/or naphthalene (the density: 1.14 g/cm³), the mass of the positive electrode 220 having the positive electrode current collector 222 and the positive electrode active material layer 224 is very light and the mass energy density of the power storage cell 112 is high.

In the present embodiment, at least a part of the positive electrode current collector 222 is formed of a material with a density lower than that of metal. At least part of the positive electrode current collector 222 may be formed of a material with a density lower than that of aluminum. For example, at least a part of the positive electrode current collector 222 is formed of resin. In this way, the power storage cell 112 may be made lighter.

In particular, when the separator 230 with a solid electrolyte as the main component is used, the mass of the separator 230 is relatively high depending on the type of solid electrolyte. Even in such a case, the increase in the total mass of the power storage cell 112 is suppressed by forming at least a part of the positive electrode current collector 222 from resin. As a result, the capacity per mass of the power storage cell 112 and the energy density of the power storage cell 112 improve.

For example, the positive electrode current collector 222 includes an electrically conductive layer including an electrically conductive material and a support layer supporting the electrically conductive layer. The details of the electrically conductive layer and the support layer are described below.

Examples of the shape of the positive electrode current collector 222 include a foil shape (sometimes referred to as a plate shape, a film shape, a sheet shape, or the like), a mesh shape, a perforated plate shape, or the like. The thickness of the positive electrode current collector 222 is not particularly limited but is preferably from 1 μm to 200 μm. The thickness of the positive electrode current collector 222 may be from 6 to 20 μm or may be from 4 to 10 μm.

In the present embodiment, the positive electrode active material layer 224 is formed on at least one face of the positive electrode current collector 222. The thickness of the positive electrode active material layer 224 may be from 1 to 100 μm or from 5 to 50 μm per one face of the positive electrode current collector 222.

The positive electrode active material layer 224 includes, for example, a positive electrode active material and a binding material (sometimes referred to as a binder). The positive electrode active material layer 224 may further include at least one of the electrically conductive material or the ion conductive material. The positive electrode active material layer 224 may include the positive electrode active material and the ion conductive material. In this way, the disruption of the ion conduction path and/or the electron conducting path formed inside the positive electrode active material layer 224 may be suppressed.

In one embodiment, the positive electrode active material layer 224 is formed by applying slurry including a material constituting the positive electrode active material layer 224 and solvent on at least one face of the positive electrode current collector 222 and drying the slurry. Examples of the above-described solvent include various solvent materials or the mixture thereof. The type of the above-described solvent material is not particularly limited but examples of the above-described solvent material include N-methylpyrrolidone (NMP), water, or the like.

In another embodiment, the positive electrode active material layer 224 is formed by mixing the material constituting the positive electrode active material layer 224, molding it into a sheet shape, and crimping the sheet-shaped mixture onto at least one face of the positive electrode current collector 222. If an organic compound is used as the positive electrode active material, the positive electrode current collector 222 and the positive electrode active material layer 224 are crimped so that excessive pressure is not applied to the positive electrode active material layer 224 in the above-described crimping process.

For example, when a precursor material of the positive electrode active material layer 224 is coated on the positive electrode current collector 222 by using a coater, the pressure applied to the precursor material of the positive electrode active material layer 224 is adjusted. For example, the pressure is set so that the coating gap by the coater is 180 μm or more. The above-described coating gap may be set to be 200 μm or more. In this way, the disruption of the ion conduction path and/or the electron conducting path in the positive electrode active material layer 224 is suppressed.

If an organic compound is used as the positive electrode active material, the ratio of the volume of the organic compound functioning as the positive electrode active material to the volume of the positive electrode active material layer 224 (sometimes referred to as an active material volume ratio) may be 60% or more. The ratio of the volume of the organic compound functioning as the positive electrode active material to the volume of the positive electrode active material layer 224 is preferably from 60 to 80%, and more preferably from 65 to 75%. When the positive electrode active material layer 224 is pressed with high pressure, the ratio of the volume of the organic compound functioning as the positive electrode active material to the volume of the positive electrode active material layer 224 exceeds 80%. When the above-described ratio exceeds 80%, the ion conduction path becomes thinner or the ion conduction path is disrupted. As a result, the capacity of the positive electrode active material layer 224 becomes lower. The above-described high pressure may refer to 50 MPa or more, may refer to 100 MPa or more, or may refer to 500 MPa or more.

On the other hand, when the ratio of the volume of the organic compound functioning as the positive electrode active material to the volume of the positive electrode active material layer 224 is less than 60%, the conductivity of the carrier ion becomes good but the density of the positive electrode active material becomes lower or the mass of the positive electrode active material included in the positive electrode active material layer 224 becomes lower. As a result, the capacity of the positive electrode active material layer 224 becomes lower.

The ratio of the volume of the organic compound functioning as the positive electrode active material to the volume of the positive electrode active material layer 224 is determined based on the observation result using, for example, 3D SEM (Scanning Electron Microscopy). For example, according to “Numerical evaluation of active material volume using 3D SEM (C0316)” proposed by Foundation for the Promotion of Material Science and Technology of Japan (https://www.mst.or.jp/casestudy/tabid/1318/pdid/87/Default.aspx), the information such as the existence ratio, the average volume, or the like of each substance in a certain volume may be obtained by repeating the SEM observation to obtain several dozen consecutive images.

The active material volume ratio in the positive electrode active material layer 224 is determined based on, for example, the magnitude of the pressure applied to the positive electrode active material layer 224 during the production process of the power storage cell 112. As the pressure applied to the positive electrode active material layer 224 increases in the production process of the power storage cell 112, the active material volume ratio in the positive electrode active material layer 224 increases. The relationship between the magnitude of the pressure applied to the positive electrode active material layer 224 and the degree of increase in the active material volume ratio in the positive electrode active material layer 224 varies depending on, for example, the type of the organic active material.

Therefore, for example, if an organic compound is used as the positive electrode active material, the maximum value of the pressure applied to the positive electrode active material layer 224 during the production process of the power storage cell 112 is adjusted or managed so that the active material volume ratio in the positive electrode active material layer 224 included in the fabricated power storage cell 112 is 80% or less. In this way, the occurrence of the phenomenon in which the net capacity of the positive electrode and/or the battery significantly decreases compared to the theoretical capacity of the positive electrode and/or the battery is prevented.

In addition, when the Young's modulus of the positive electrode active material layer 224 is smaller, the degree of increase in the active material volume ratio due to high pressure applied to the positive electrode active material layer 224 may increase. Therefore, when the positive electrode active material is an organic compound, the Young's modulus of the positive electrode active material layer 224 may be adjusted to be approximately the same as the Young's modulus of the separator 230. For example, when the separator 230 is mainly constituted of polymer solid electrolyte and the positive electrode active material is an organic compound, the material and/or the manufacturing condition of the positive electrode active material layer 224 is determined so that the ratio of the Young's modulus of the polymer solid electrolyte to the Young's modulus of the positive electrode active material is from 0.7 to 1.3.

The above-described Young's modulus is measured through, for example, the bending test defined in the JIS K 7171. In the above-described bending test, it is set so that the strain rate is about 1%/min.

It is noted that the Young's modulus of the positive electrode active material layer 224 is not particularly limited. For example, when the pressure applied to the positive electrode active material layer 224 during the production process of the power storage cell 112 is relatively small, the material of the positive electrode active material layer 224 may be arbitrarily determined without considering the Young's modulus of the positive electrode active material layer 224.

In addition, according to the present embodiment, during the securing process of the positive electrode current collector 222 and the positive electrode active material layer 224, the pressure applied to the positive electrode current collector 222 and the positive electrode active material layer 224 is also set or adjusted as described above. In this way, even if the electrically conductive layer included in the positive electrode current collector 222 is thin, the fracture of the electrically conductive layer is suppressed. As a result, the increase in the electrical resistance of the positive electrode current collector 222 is suppressed. According to the present embodiment, not only the reduction in the capacity due to the decrease of the ion conduction path and/or the electrically conductive path of the positive electrode active material layer 224 is suppressed, but the reduction in the capacity due to the increase in the electrical resistance of the positive electrode current collector 222 may also be suppressed.

As described above, according to the present embodiment, the pressure during the securing process is set or adjusted so that the ratio of the volume of the organic compound functioning as the positive electrode active material to the volume of the positive electrode active material layer 224 is from 60 to 80%. In this case, the ratio of the volume of voids to the volume of the positive electrode active material layer 224 (sometimes referred to as the void ratio, the porosity, or the like) is from 25 to 40%.

### (Positive Electrode Active Material)

Various substances that can absorb and release the carrier ion of the power storage cell 112 are used as the positive electrode active material included in the positive electrode active material layer 224. In the present embodiment, the positive electrode active material is mainly constituted of one or more types of organic compounds. The positive electrode active material may include an inorganic compound. For example, 80% by mass or more of the positive electrode active material included in the positive electrode active material layer 224 is constituted of organic compounds.

As described above, the positive electrode 220 has the positive electrode current collector 222 and the positive electrode active material layer 224. The mass of the positive electrode active material layer 224 may be 80% or more of the total mass of the positive electrode 220. The mass of the positive electrode active material may be 80% or more of the total mass of the positive electrode active material layer 224. The mass of the organic compound used as the positive electrode active material may be 80% or more of the total mass of the positive electrode active material.

Examples of the inorganic compound used as the positive electrode active material (sometimes referred to as an inorganic positive electrode active material) include metal oxide, metal silicate, metal phosphate, metal borate, or the like. Examples of the above-described metal include transition metals such as V, Mn, Ni, Co, or the like.

For the organic compound used as the positive electrode active material (sometimes referred to as the organic positive electrode active material), various redox-active compounds are used as the organic positive electrode active material. Examples of the organic positive electrode active material include a conjugated polymer, a disulfide, a quinone, a localized radical, a delocalized radical, or the like.

The organic positive electrode active material may be at least one type of compound selected from the group consisting of an aromatic hydrocarbon, an aromatic heterocyclic compound, an alkene substituted by one or more cyano groups, a disulfide, and the derivatives thereof, as well as the compounds including the structures or structural units derived from them. If the organic positive electrode active material is a compound including the above-described structural unit, the polymerization degree may be 100 or less. The above-described derivative may be a compound in which one or more hydrogens are substituted by a ketone group, an OH group, an OM group (M is a metal, and examples of M include a carrier metal of a battery, an alkali metal, an alkali earth metal, or the like), a nitro group, or the like.

The organic positive electrode active material may be at least one type of a compound selected from the group consisting of a compound including a structure in which at least two oxygen atoms are bonded to a benzene ring, a compound including a structure in which at least two hydroxyl groups are bonded to a benzene ring, a compound including a structure in which at least two carbon atoms of a benzene ring are substituted by nitride atoms, a compound including a structure in which at least two cyano groups are bonded to a double bond between carbons, a compound including a disulfide bond, and derivatives thereof, as well as compounds including a structure or a structural unit derived from them. If the organic positive electrode active material is a compound including the above-described structural unit, the polymerization degree may be 100 or less. The above-described derivative may be a compound in which one or more hydrogens are substituted by a ketone group, an OH group, an OM group (M is a metal, and examples of M include a carrier metal of a battery, an alkali metal, an alkali earth metal, or the like), a nitro group, or the like.

The compound including a structure derived from a particular compound may be a compound including a group or a structure obtained by removing at least one hydrogens included in the particular compound. The compound including the structure derived from the particular compound may be a monomer of the compound or may be a dimer or polymer. For example, examples of a compound including a structure derived from benzoquinone, which is one example of the derivative of the aromatic hydrocarbons, include the derivative of a polycyclic aromatic hydrocarbon such as naphthoquinone, anthraquinone, phenanthrenequinone, or the like.

For example, 1,4-naphthoquinone, 5,8-dihydroxy-1,4-naphthoquinone, and 9,10-anthraquinone include a structure derived from benzoquinone. 5,8-dihydroxy-1,4-naphthoquinone (sometimes referred to as naphthazarin) may be one example of a compound including the structure derived from 1,4-naphthoquinone. In addition, 9,10-anthraquinone may be one example of a compound including the structure derived from 1,4-naphthoquinone.

Similarly, examples of a compound including the structural unit derived from a particular compound include a polymer or an oligomer including, as a repeated unit, the particular compound or a group or structure obtained by removing at least one hydrogen included in the particular compound. As described above, the compound including the structural unit derived from the particular compound is preferably an oligomer with a polymerization degree of 100 or less. In this way, a battery with a high mass energy density may be fabricated.

The organic positive electrode active material may be a compound that results in the capacity of the positive electrode active material layer 224 less than 50% of the theoretical capacity of the positive electrode active material layer 224 when the active material volume ratio in the positive electrode active material layer 224 exceeds 80%. The organic positive electrode active material may be a compound that results in the capacity of the positive electrode active material layer 224 less than 50% of the theoretical capacity of the positive electrode active material layer 224 when the active material volume ratio in the positive electrode active material layer 224 exceeds 80%, and that results in the capacity of the positive electrode active material layer 224 equal to or more than 50% (more preferably, equal to or more than 70%) of the theoretical capacity of the positive electrode active material layer 224 when the active material volume ratio in the positive electrode active material layer 224 is from 65 to 75%. As described above, according to the present embodiment, even if such an organic compound is used as the positive electrode active material of the battery, a battery with a high capacity may be fabricated.

Examples of such organic compounds include an organic molecule having a relatively low molecular weight and a multi-electron transfer capacity. If the above-described organic molecule is a low molecular weight compound, the molecular weight of the organic molecule is, for example, 500 or less. The molecular weight of the above-described organic molecule may be 200 or less. If the above-described organic molecule is a polymer or an oligomer, the molecular weight of the organic molecule is, for example, 5000 or less. The molecular weight of the above-described organic molecule may be 3000 or less.

The organic positive electrode active material may be at least one type of compound selected from a group consisting of organic compounds with solubility in ethylene carbonate (EC) ranging from 0.01 to 40 [mmol/l-EC] under the condition of 0.1013 MPa and 25° C. and organic compounds with solubility in diethyl carbonate (DEC) ranging from 0.01 to 40 [mmol/l-DEC] under the condition of 0.1013 MPa and 25° C. The upper limit of the numerical range related to the above-described solubility is preferably 10 [mmol/l-solvent]. As described above, according to the present embodiment, even if such an organic compound is used as the positive electrode active material of the battery, a battery with a relatively longer life may be fabricated.

Examples of such organic compounds include an organic molecule having a relatively low molecular weight and a multi-electron transfer capacity. If the above-described organic molecule is a low molecular weight compound, the molecular weight of the organic molecule is, for example, 500 or less. The molecular weight of the above-described organic molecule may be 200 or less. If the above-described organic molecule is a polymer or an oligomer, the molecular weight of the organic molecule is, for example, 5000 or less. The molecular weight of the above-described organic molecule may be 3000 or less.

As described above, when the organic active material of the power storage cell 112 is more soluble in the electrolytic solution or the solvent of the gel electrolyte, the effect of the power storage cell 112 substantially not including the electrolytic solution or the gel electrolyte is higher. Ethylene carbonate (EC) and diethyl carbonate (DEC) are non-proton organic solvents widely used as the solvent of the electrolytic solution or the gel electrolyte. Therefore, if the positive electrode active material layer 224 includes the organic compound that has the above-described solubility, the effect of the power storage cell 112 substantially not including the electrolytic solution or the gel electrolyte may be higher.

Specific examples of the organic positive electrode active material include at least one type of compound selected from a group consisting of the compounds represented by each chemical formula described below and the derivatives thereof as well as the compounds including the structure or the structural unit derived from them. As described above, the compound including the structure derived from a particular compound may be a compound including the group or structure obtained by removing at least one hydrogens included in the particular compound. Similarly, examples of a compound including the structural unit derived from a particular compound include a polymer or an oligomer including, as a repeated unit, the particular compound or a group or structure obtained by removing at least one hydrogen included in the particular compound.

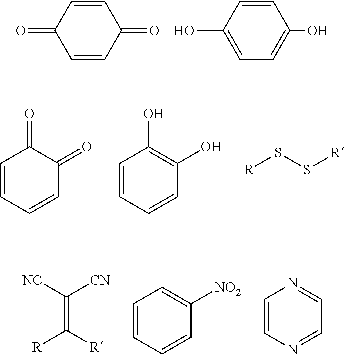

The above-described derivative may be a compound in which one or more hydrogens are substituted by a deuterium, a hydroxyl group, an OM group (M is a metal, and examples of M include a carrier metal of a battery, an alkali metal, an alkali earth metal, or the like), a halogen, various organic groups, or the like. The molecular weight of at least one type of compound selected from the above-described group is, for example, 500 or less. The molecular weight of at least one type of compound selected from the above-described group may be 200 or less. The compound including the above-described structural units is preferably an oligomer with a polymerization degree of 100 or less.

In the above-described chemical formula, each of R and R′ independently indicates a hydrogen, a deuterium, a hydroxyl group, an OM group (M is a metal, and examples of M include a carrier metal of a battery, an alkali metal, an alkali earth metal, or the like), a nitro group, an amino group, a sulfonate group, or an organic group. Examples of the above-described organic group include various monovalent groups. Examples of the above-described organic group include groups including an alkyl group, alkenyl group, ketone group, carboxyl group, carbonyl group, aryl group, cyano group, heterocycle, or the like. Each of R and R′ may be one independently selected from groups including a hydrogen, a deuterium, a hydroxyl group, an OM group (M is a metal, and examples of M include a carrier metal of a battery, an alkali metal, an alkali earth metal, or the like), a ketone group, a cyano group, a carbonyl group, and a heterocycle.

The above-described organic group may be a monovalent group having a structure derived from a compound represented by each chemical formula described below or a derivative thereof.

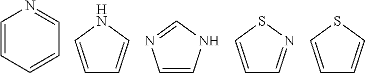

The monovalent group having a structure derived from the compound represented by each of the above-described chemical formulas may be a group obtained by removing one of the hydrogens bonded to an aromatic ring in each of the above-described chemical formulas. The derivative of the compound represented by each of the above-described chemical formulas may be a compound in which one or more hydrogens in the above-described chemical formulas are substituted by a deuterium, a halogen, a hydroxyl group, an OM group (M is a metal and examples of M include a carrier metal of a battery, an alkali metal, an alkali earth metal, or the like), a nitro group, an amino group, a sulfonate group, an organic group, or the like. The monovalent group having a structure derived from the above-described derivative may be a group obtained by removing one of the hydrogens bonded to the aromatic ring of the derivative.

For example, if the separator 230 is mainly constituted of a solid electrolyte layer including at least one type of compound selected from polyethylene oxide (PEO), poly(3,4-ethylenedioxythiophene) (PEDOT), and the derivatives thereof, the positive electrode active material layer 224 includes, as the organic positive electrode active material, at least one type of compounds selected from the group consisting of the compound represented by each of the above-described chemical formulas and the derivatives thereof, as well as a compound including a structure or a structural unit derived from them. In this way, the decrease in the capacity of the above-described organic positive electrode active material is suppressed.

The compound represented by each of the above-described chemical formulas and the derivatives thereof have a low molecular weight and a multi-electron transfer capacity. Therefore, when they are used as the active material of the power storage cell 112, the energy density and/or capacity of the power storage cell 112 improve. Particularly, according to the present embodiment, the power storage cell 112 substantially does not include an electrolytic solution or gel electrolyte. In addition, the positive electrode active material layer 224 has a porosity of 20% or more. In this way, the energy density and/or capacity of the power storage cell 112 further improves.

Among the above-described chemical formulas, examples of the compound including the structure derived from p-benzoquinone include 5,8-dihydroxy-1,4-naphthoquinone (sometimes referred to as naphthazarin), naphthazarin dimer, or the like. Similarly, examples of the compound including a structure derived from p-benzendiol include naphthazarin, naphthazarin dimer, or the like. When these compounds are used as the positive electrode active material, a battery with a high energy density may be fabricated.

The compound including the structure derived from p-benzoquinone may be 2,4-dihydroxy-p-benzoquinone. In addition, among the above-described chemical formulas, examples of the compound including the structure derived from o-benzoquinone include 4-nitro-1,2-benzoquinone or the like. When these compounds are used as the positive electrode active material, a battery with a high energy density may be fabricated.

(Material Other than Positive Electrode Active Material)

The binding material included in the positive electrode active material layer 224 binds the material constituting the positive electrode active material layer 224 and retains the electrode shape of the positive electrode 220. As the binding material, for example, various polymeric materials are used. Examples of the above-described polymeric material include carboxymethyl cellulose, styrene-butadiene rubber, polyvinylidene fluoride (PVdF), polytetrafluoroethylene (PTFE), polyacrylic acid, polyethylene oxide (PEO), poly(3,4-ethylenedioxythiophene) (PEDOT) and the derivatives thereof or the like.

The binding material may be a material that dissolves in a solvent for which the solubility of the organic positive electrode active material is higher than a predetermined value. The solubility of the binding material in the above-described solvent may be equivalent to or more than the solubility of the organic positive electrode active material in the above-described solvent. In this way, for example, when the constituent material of the power storage cell 112 is reused, the dismantling process of the power storage cell 112 is easier.

The electrically conductive material included in the positive electrode active material layer 224 improves the electrical conductivity of the positive electrode active material layer 224. In this way, the resistance of the positive electrode 220 becomes lower. The electrically conductive material is not particularly limited as long as it is a material having electron conductivity. Examples of electrically conductive materials include a carbon-based material, a metal-based material, an electrically conductive polymer material, or the like. These electrically conductive materials may be used alone or two or more types of electrical conductivity enhancers may be combined.

Examples of carbon-based materials include graphite, carbon black (for example, acetylene black, Ketjen black, or the like), coke, amorphous carbon, carbon fiber, carbon nanotube, graphene, or the like. Examples of metal-based materials include aluminum, gold, silver, copper, iron, platinum, chromium, tin, indium, titanium, nickel, or the like. Examples of the electrically conductive polymer material include a polyphenylene derivative or the like.

The electrically conductive material may be a material that dissolves in a solvent for which the solubility of the organic positive electrode active material is higher than a predetermined value. The solubility of the electrically conductive material in the above-described solvent may be equivalent to or more than the solubility of the organic positive electrode active material in the above-described solvent. In this way, for example, when the constituent material of the power storage cell 112 is reused, the dismantling process of the power storage cell 112 is easier.

The conductive material included in the positive electrode active material layer 224 improves the conductivity of the carrier ion in the positive electrode active material layer 224. As the conductive material, for example, various solid electrolytes are used. Examples of solid electrolytes include a sulfide-based solid electrolyte, an oxide-based solid electrolyte, a polymer solid electrolyte, or the like. As the conductive material, a polymer solid electrolyte may be used. Examples of polymer solid electrolytes include polyethylene oxide (PEO), poly(3,4-ethylenedioxythiophene) (PEDOT), and at least one type of compound selected from these derivatives.

As described below, in the present embodiment, the separator 230 includes a polymer solid electrolyte. The type of the polymer solid electrolyte used as the conductive material may be the same as or different from the type of the polymer solid electrolyte included in the separator 230.

The conductive material may be a material that dissolves in a solvent for which the solubility of the organic positive electrode active material is higher than a predetermined value. The solubility of the conductive material in the above-described solvent may be equivalent to or more than the solubility of the organic positive electrode active material in the above-described solvent. In this way, for example, when the constituent material of the power storage cell 112 is reused, the dismantling process of the power storage cell 112 is easier.

### (Separator)

In the present embodiment, the separator 230 is arranged between the positive electrode 220 and the negative electrode 240 and separates the positive electrode 220 and the negative electrode 240. In addition, the separator 230 ensures the conductivity of carrier ions between the positive electrode 220 and the negative electrode 240. The thickness of the separator 230 is not particularly limited but is preferably from 10 μm to 50 μm.

In the present embodiment, the separator 230 includes a layer-shaped (sometimes referred to as board-shaped, film-shaped, sheet-shaped, or the like) solid electrolyte (sometimes referred to as a solid electrolyte layer). In this way, the solid electrolyte layer functions as the separator of the power storage cell 112.

In one embodiment, as the separator 230, the solid electrolyte layer is used. The solid electrolyte layer may be constituted of a single solid electrolyte layer or may be constituted of a plurality of solid electrolyte layers. In another embodiment, as the separator 230, a stack of one or more solid electrolyte layers and another layer including a material other than the solid electrolyte is used. The other layer may have ion conductivity. Examples of the other layer include a composite material including resin in which a plurality of through-holes are formed and an ion conductive material filling inside the through-hole.

In this way, a secondary battery including no electrolytic solution or gel electrolyte may be fabricated. As a result, even if the positive electrode active material layer 224 and/or the negative electrode active material layer 244 includes an organic active material as a main active material, the decrease in the battery life due to the organic active material dissolving in the electrolytic solution or the solvent of the gel electrolyte may be suppressed.

It is noted that the separator 230 is not limited to the above-described embodiment. For example, a porous material in which the solid electrolyte is arranged inside the pores is used as the separator 230. The separator 230 may be fabricated by immersing an appropriate support material or retention material in the gel electrolyte or the electrolytic solution to allow the gel electrolyte or the electrolytic solution to infiltrate inside the support material or the retention material and then solidifying the electrolyte arranged inside the support material or the retention material. For example, the electrolyte arranged inside the support material or the retention material is solidified by drying the support material or the retention material including the gel electrolyte or the electrolytic solution.

Examples of the electrolytic solution or the solvent of the gel electrolyte include ethylene carbonate (EC), propylene carbonate (PC), dimethyl carbonate (DMC), diethyl carbonate (DEC), ethyl methyl carbonate (EMC), butylene carbonate (BC), fluoroethylene carbonate (FEC), γ-butyrolactone, sulfolane, acetonitrile, 1,2-dimethoxymethane, 1,3-dimethoxypropane, diethyl ether, tetrahydrofuran, 2-methyltetrahydrofuran, and mixtures thereof. In particular, ethylene carbonate (EC), dimethyl carbonate (DMC), diethyl carbonate (DEC), and ethyl methyl carbonate (EMC) are widely used as the electrolytic solution or the solvent of the gel electrolyte.

### (Solid Electrolyte Layer)

In the present embodiment, the separator 230 includes a solid electrolyte layer including the polymer solid electrolyte as the main constituent material. The solid electrolyte layer includes, for example, 80% by mass or more of a true polymer solid electrolyte. If the separator 230 includes the polymer solid electrolyte as the main constituent material, the separator 230 may be joined to the positive electrode 220 and/or the negative electrode 240 without being subjected to the high pressure press process.

As a result, for example, even if the positive electrode active material layer 224 and/or the negative electrode active material layer 244 includes an organic active material, the positive electrode active material layer 224 and/or the negative electrode active material layer 244 having a porosity of 20% or more is obtained. As described above, if the porosity of the positive electrode active material layer 224 and/or the negative electrode active material layer 244 is 20% or more, the power storage cell 112 with a high ratio of the capacity of the positive electrode active material layer 224 and/or the negative electrode active material layer 244 to the theoretical capacity is obtained. The ratio of the capacity of the positive electrode active material layer 224 and/or the negative electrode active material layer 244 to the theoretical capacity is preferably 50% or more, more preferably 60% or more, and even more preferably 70% or more.

For example, the solid electrolyte layer is fabricated by applying slurry including the material constituting the solid electrolyte layer and solvent onto a smooth support plate and drying the slurry. Examples of the above-described solvent include various solvents or a mixture thereof. The type of the above-described solvent is not particularly limited but examples of the above-described solvent include N-methylpyrrolidone (NMP), water, methanol, or the like.

As the polymer solid electrolyte constituting the solid electrolyte layer, for example, a polymeric material having the ion conductivity of 1×10⁻⁴ [S/cm] or more under the condition of 60° C. is used. If an organic compound is used as the positive electrode active material and/or the negative electrode active material of the power storage cell 112, at least one of the type, composition, or molecular weight of the polymeric material may be determined such that the ratio of the Young's modulus of the above-described polymeric material to the Young's modulus of the organic compound is from 0.7 to 1.3.

In this way, the decrease in the porosity of the active material during the production process or use process of the power storage cell 112 is further suppressed. It is noted that if the solid electrolyte layer is mainly constituted of a polymer solid electrolyte, the pressure inside the power storage cell 112 during the use process of the power storage cell 112 is typically approximately from 0.1 to 0.2 [MPa]. On the other hand, if the solid electrolyte layer is mainly constituted of inorganic solid electrolytes, the pressure inside the power storage cell during the use process of the power storage cell is typically pressurized to approximately 500 [MPa].

Examples of the polymer solid electrolyte constituting the solid electrolyte layer include at least one type of compound selected from polyethylene oxide (PEO), poly(3,4-ethylenedioxythiophene) (PEDOT), and the derivatives thereof. The solid electrolyte layer may be substantially constituted of a single polymer solid electrolyte or may include two or more types of polymer solid electrolyte.

### (Negative Electrode)

In the present embodiment, the negative electrode current collector 242 retains the negative electrode active material layer 244. Examples of the material of the negative electrode current collector 242 include copper, aluminum, stainless steel, nickel, titanium, an alloy thereof, or the like.

The negative electrode current collector 242 may include an electrically conductive resin. The negative electrode current collector 242 may be an electrically conductive resin. In one embodiment, the electrically conductive resin includes an electrically conductive polymer. In another embodiment, the electrically conductive resin may be a polymer including an electrical conductivity filler.

The negative electrode current collector 242 may have a constitution similar to that of the positive electrode current collector 222. For example, the negative electrode current collector 242 includes an electrically conductive layer including the electrically conductive material and a support layer supporting the electrically conductive layer. The support layer is formed of a material with a density lower than that of metal. The support layer may be formed of a material with a density lower than that of aluminum. For example, the support layer is formed of resin. In this way, the power storage cell 112 may be made lighter.

If carrier metal is used as the negative electrode active material, the carrier metal may also work as the current collector. For example, if the carrier metal of the power storage cell 112 is lithium and the negative electrode active material is lithium metal, the lithium metal is used as the current collector. In this case, the power storage cell 112 may not have to include the negative electrode current collector 242.

Examples of the shape of the negative electrode current collector 242 include a foil shape (sometimes referred to as a plate shape, a film shape, or the like), a mesh shape, a perforated plate shape, or the like. The thickness of the negative electrode current collector 242 is not particularly limited but may be from 1 μm to 200 μm. The thickness of the negative electrode current collector 242 may be from 4 to 20 μm or may be from 6 to 10 μm.

In the present embodiment, the negative electrode active material layer 244 is formed on at least one face of the negative electrode current collector 242. The thickness of the negative electrode active material layer 244 may be from 0 μm to 200 μm, or may be from 1 μm to 100 μm per one face of the negative electrode current collector 242.

The negative electrode active material layer 244 includes, for example, a negative electrode active material and a binding material (sometimes referred to as a binder). The negative electrode active material layer 244 may further include at least one of the electrically conductive material or the ion conductive material. The negative electrode active material layer 244 may include the negative electrode active material and the ion conductive material. In this way, the disruption of the ion conduction path and/or the electron conducting path formed inside the negative electrode active material layer 244 may be suppressed.

In one embodiment, the negative electrode active material layer 244 is fabricated by applying slurry including a material constituting the negative electrode active material layer 244 and organic solvent onto at least one face of the negative electrode current collectors 242 and drying the slurry. Examples of the above-described solvent include various solvent materials or the mixture thereof. The type of the above-described solvent material is not particularly limited but examples of the above-described solvent material include N-methylpyrrolidone (NMP), water, or the like.

In another embodiment, the negative electrode active material layer 244 is formed by mixing the material constituting the negative electrode active material layer 244, molding it into a sheet shape, and then crimping the mixture with the sheet shape onto at least one face of the negative electrode current collector 242. If an organic compound is used as the negative electrode active material, the negative electrode current collector 242 and the negative electrode active material layer 244 are crimped such that excessive pressure is not applied to the negative electrode active material layer 244 during the above-described crimping process.

For example, when the precursor material of the negative electrode active material layer 244 is coated onto the negative electrode current collector 242 by using a coater, the pressure applied to the precursor material of the negative electrode active material layer 244 is adjusted. For example, the pressure is set so that the coating gap by the coater is 180 μm or more. The above-described coating gap may be set to be 200 μm or more. In this way, the disruption of the ion conduction path and/or the electron conducting path in the negative electrode active material layer 244 is suppressed.

If an organic compound is used as the negative electrode active material, the ratio of the volume of the organic compound functioning as the negative electrode active material to the volume of the negative electrode active material layer 244 (sometimes referred to as the active material volume ratio) may be 60% or more. The ratio of the volume of the organic compound functioning as the negative electrode active material to the volume of the negative electrode active material layer 244 is preferably from 60 to 80%, and more preferably from 65 to 75%.

When the negative electrode active material layer 244 is pressed with high pressure, the ratio of the volume of the organic compound functioning as the negative electrode active material to the volume of the negative electrode active material layer 244 exceeds 80%. When the above-described ratio exceeds 80%, the ion conduction path becomes thinner or the ion conduction path is disrupted. As a result, the capacity of the negative electrode active material layer 244 becomes lower. The above-described high pressure may mean 50 MPa or more, may mean 100 MPa or more, or may mean 500 MPa or more.

On the other hand, when the ratio of the volume of the organic compound functioning as the negative electrode active material to the volume of the negative electrode active material layer 244 is less than 60%, the conductivity of the carrier ion becomes better but the density of the negative electrode active material becomes lower or the mass of the positive electrode active material included in the negative electrode active material layer 244 becomes smaller. As a result, the capacity of the negative electrode active material layer 244 becomes lower.

The active material volume ratio in the negative electrode active material layer 244 is derived by a procedure similar to that of the active material volume ratio in the positive electrode active material layer 224. For example, the active material volume ratio in the negative electrode active material layer 244 is determined based on the observation result obtained by using a 3D SEM (Scanning Electron Microscopy).

The active material volume ratio in the negative electrode active material layer 244 is determined based on, for example, the magnitude of the pressure applied to the negative electrode active material layer 244 during the production process of the power storage cell 112. When the pressure applied to the negative electrode active material layer 244 during the production process of the power storage cell 112 increases, the active material volume ratio in the negative electrode active material layer 244 increases. The relationship between the magnitude of the pressure applied to the negative electrode active material layer 244 and the degree of increase in the active material volume ratio in the negative electrode active material layer 244 varies depending on, for example, the type of the organic active material.

Therefore, for example, if an organic compound is used as the negative electrode active material, the maximum value of the pressure applied to the negative electrode active material layer 244 during the production process of the power storage cell 112 is adjusted or managed such that the active material volume ratio in the negative electrode active material layer 244 included in the fabricated power storage cell 112 is 80% or less. In this way, the occurrence of the phenomenon in which the net capacity of the negative electrode and/or the battery significantly decreases compared to the theoretical capacity of the negative electrode and/or the battery is prevented.

In addition, when the Young's modulus of the negative electrode active material layer 244 is lower, the degree of increase in the active material volume ratio due to the high pressure being applied to the negative electrode active material layer 244 may be higher. Therefore, if the negative electrode active material is an organic compound, the Young's modulus of the negative electrode active material layer 244 may be adjusted to be approximately the same as the Young's modulus of the separator 230. For example, when the separator 230 is mainly constituted of polymer solid electrolyte and the negative electrode active material is an organic compound, the material and/or the manufacturing condition of the negative electrode active material layer 244 is determined so that the ratio of the Young's modulus of the polymer solid electrolyte to the Young's modulus of the negative electrode active material is from 0.7 to 1.3.

The above-described Young's modulus is measured through, for example, the bending test defined in the JIS K 7171. In the above-described bending test, it is set so that the strain rate is about 1%/min.

It is noted that the Young's modulus of the negative electrode active material layer 244 is not particularly limited. For example, if the pressure applied to the negative electrode active material layer 244 during the production process of the power storage cell 112 is relatively small, the material of the negative electrode active material layer 244 may be arbitrarily determined without considering the Young's modulus of the negative electrode active material layer 244.

As described below, the foil of carrier metal such as lithium metal is sometimes used as the negative electrode active material layer. In this case, the material of the negative electrode active material layer may be determined without considering the Young's modulus of the negative electrode active material layer.

### (Negative Electrode Active Material)

Various substances that can absorb and release the carrier ion of the power storage cell 112 are used as the negative electrode active material included in the negative electrode active material layer 244. The negative electrode active material may be an inorganic compound or may be an organic compound. These negative electrode active materials may be used alone or two or more types of the negative electrode active material may be combined. For example, the metal foil that can release carrier ions of the power storage cell 112 is used as the negative electrode active material layer 244. In this way, the mass energy density of the power storage cell 112 improves.

If the negative electrode current collector 242, like the positive electrode current collector 222, includes the electrically conductive layer including the electrically conductive material and the support layer supporting the electrically conductive layer, according to one embodiment, a metal that can release the carrier ion of the power storage cell 112 (for example, Li metal) is used as the negative electrode active material. In this case, approximately the entire negative electrode active material included in the negative electrode active material layer 244 is constituted of the metal. In another embodiment, the negative electrode active material may be mainly constituted of one or more types of organic compounds. The negative electrode active material may include an inorganic compound. For example, 80% by mass or more of the negative electrode active material included in the negative electrode active material layer 244 is constituted of the organic compound.

Examples of the inorganic compound used as the negative electrode active material (sometimes referred to as an inorganic negative electrode active material) include (i) a carrier metal and an alloy including it, (ii) tin, silicon, and an alloy including them, (iii) silicon oxide, (iv) titanium oxide, or the like. For example, if the power storage cell 112 is a lithium secondary battery, metallic lithium, lithium titanium oxide (LTO), or the like are used as the negative electrode active material. If the material including no carrier metal is used as the negative electrode active material, carrier metal may be pre-doped into the material.

The organic compound used as the negative electrode active material (sometimes referred to as an organic negative electrode active material) may be at least one type of compound selected from a group consisting of an aromatic heterocyclic compound and a derivative thereof and a compound including a structure or structural unit derived from them. If the organic negative electrode active material is a compound including the above-described structural unit, the polymerization degree may be 100 or less. The above-described derivative may be a compound in which one or more hydrogens are substituted by a ketone group, an OH group, an OM group (M is a metal, and examples of M include a carrier metal of a battery, an alkali metal, an alkali earth metal, or the like), a nitro group, or the like.

As described above, the negative electrode active material layer 244 may include a foil-shaped carrier metal. For example, the negative electrode active material layer 244 includes a lithium metal foil. In this way, the carrier metal is supplied to the power storage cell 112. The thickness of the metal foil may be from 1 to 200 μm, may be from 10 to 100 μm, or may be from 20 to 50 μm. The thickness and/or the mass of the metal foil may be determined depending on the content of the positive electrode active material in the positive electrode active material layer 224.

(Material Other than Negative Electrode Active Material)

The binding material included in the negative electrode active material layer 244 binds the material constituting the negative electrode active material layer 244 and retains the electrode shape of the negative electrode 240. As the binding material, for example, various polymeric materials are used. Examples of the above-described polymeric material include carboxymethyl cellulose, styrene-butadiene rubber, polyvinylidene fluoride (PVdF), polytetrafluoroethylene (PTFE), polyacrylic acid, polyethylene oxide (PEO), poly(3,4-ethylenedioxythiophene) (PEDOT) and the derivatives thereof or the like.

The binding material may be a material that dissolves in a solvent for which the solubility of the organic negative electrode active material is higher than a predetermined value. The solubility of the binding material in the above-described solvent may be equivalent to or more than the solubility of the organic negative electrode active material in the above-described solvent. In this way, for example, when the constituent material of the power storage cell 112 is reused, the dismantling process of the power storage cell 112 is easier.

The electrically conductive material included in the negative electrode active material layer 244 improves the electrical conductivity of the negative electrode active material layer 244. In this way, the resistance of the negative electrode 240 becomes lower. The electrically conductive material is not particularly limited as long as it is a material having electron conductivity. Examples of electrically conductive materials include a carbon-based material, a metal-based material, an electrically conductive polymer material, or the like. These electrically conductive materials may be used alone or two or more types of electrical conductivity enhancers may be combined.

Examples of carbon-based materials include graphite, carbon black (for example, acetylene black, Ketjen black, or the like), coke, amorphous carbon, carbon fiber, carbon nanotube, graphene, or the like. Examples of the metal-based material include aluminum, gold, silver, copper, iron, platinum, chromium, tin, indium, titanium, nickel, or the like. Examples of the electrically conductive polymer material include a polyphenylene derivative or the like.

The electrically conductive material may be a material that dissolves in a solvent for which the solubility of the organic negative electrode active material is higher than a predetermined value. The solubility of the binding material in the above-described solvent may be equivalent to or more than the solubility of the organic negative electrode active material in the above-described solvent. In this way, for example, when the constituent material of the power storage cell 112 is reused, the dismantling process of the power storage cell 112 is easier.

The conductive material included in the negative electrode active material layer 244 improves the conductivity of the carrier ion in the negative electrode active material layer 244. As the conductive material, for example, various solid electrolytes are used. Examples of solid electrolytes include a sulfide-based solid electrolyte, an oxide-based solid electrolyte, a polymer solid electrolyte, or the like. As the conductive material, a polymer solid electrolyte may be used. Examples of polymer solid electrolytes include polyethylene oxide (PEO), poly(3,4-ethylenedioxythiophene) (PEDOT), and at least one type of compound selected from these derivatives.

As described above, in the present embodiment, the separator 230 includes a polymer solid electrolyte. The type of polymer solid electrolyte used as the conductive material may be the same as or different from the type of polymer solid electrolyte included in the separator 230.

The conductive material may be a material that dissolves in a solvent for which the solubility of the organic negative electrode active material is higher than a predetermined value. The solubility of the conductive material in the above-described solvent may be equivalent to or more than the solubility of the organic negative electrode active material in the above-described solvent. In this way, for example, when the constituent material of the power storage cell 112 is reused, the dismantling process of the power storage cell 112 is easier.

The positive electrode case 212 may be one example of the housing. The negative electrode case 214 may be one example of the housing. The positive electrode 220 may be one example of the electrode. The positive electrode current collector 222 may be one example of the current collector. The positive electrode active material layer 224 may be one example of the active material layer. The negative electrode 240 may be one example of the electrode. The negative electrode current collector 242 may be one example of the current collector. The negative electrode active material layer 244 may be one example of the active material layer. The organic active material may be one example of an organic compound. The organic positive electrode active material may be one example of an organic compound. The organic negative electrode active material may be one example of an organic compound.

### (One Example of Another Embodiment)

In the present embodiment, the detail of the power storage cell 112 is described by using an example in which the power storage cell 112 is a coin-shaped secondary battery. However, the type, structure, or the like of the power storage cell 112 is not limited to the present embodiment. In another embodiment, the power storage cell 112 may be a cylindrical battery including a wound electrode body in which a positive electrode, a separator, and a negative electrode are wound in a spiral shape. In yet another embodiment, the power storage cell 112 may be a lamination battery in which stack electrode body in which positive electrodes and negative electrodes are stacked on each other with the separators sandwiched between them is sealed with lamination. In yet another embodiment, the structure 260 includes a plurality of stacked positive electrodes 220 and the positive electrode current collectors 222 of each of the stacked positive electrodes 220 may be integrated in a part of the stacked positive electrodes 220. In this case, the structure 260 may be one example of the stack or the electrode structure. In yet another embodiment, the structure 260 includes a plurality of stacked negative electrodes 240 and the negative electrode current collectors 242 of each of the stacked negative electrodes 240 may be integrated in a part of the stacked negative electrode 240. In this case, the structure 260 may be one example of the stack or the electrode structure.

In the present embodiment, the detail of the power storage cell 112 is described by using an example in which the negative electrode 240 has the negative electrode current collector 242 and the negative electrode active material layer 244. However, the negative electrode of the power storage cell 112 is not limited to the present embodiment. In another embodiment, a foil-shaped carrier metal functions as the negative electrode current collector 242 and the negative electrode active material layer 244. For example, if the power storage cell 112 is a lithium metal secondary battery, metallic lithium may be used as the negative electrode.

In the present embodiment, the detail of the power storage cell 112 is described by using an example in which the positive electrode current collector 222 has (i) the electrically conductive layer including the electrically conductive material and (ii) the support layer supporting the electrically conductive layer, the positive electrode active material layer 224 mainly includes the organic compound as the active material, and the negative electrode 240 has any constitution. However, the negative electrode of the power storage cell 112 is not limited to the present embodiment.

In another embodiment, the negative electrode current collector 242 has (i) the electrically conductive layer including the electrically conductive material and (ii) the support layer supporting the electrically conductive layer, the negative electrode active material layer 244 mainly includes the organic compound as the active material, and the positive electrode 220 may have any constitution. In yet another embodiment, the positive electrode current collector 222 and the negative electrode current collector 242 have (i) the electrically conductive layer including the electrically conductive material and (ii) the support layer supporting the electrically conductive layer, the positive electrode active material layer 224 and the negative electrode active material layer 244 may mainly include the organic compound as the active material.

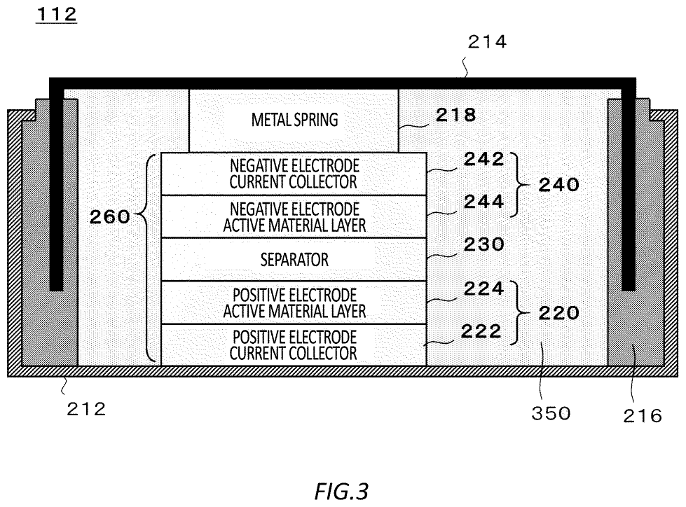

FIG. 3 schematically illustrates another example of the power storage cell 112. The power storage cell 112 described with reference to FIG. 3 is different from the power storage cell 112 described with reference to FIG. 2 in that, in addition to the metal spring 218, the positive electrode 220, the separator 230, and the negative electrode 240, the liquid or gel-like electrolyte 350 is accommodated inside the space formed by positive electrode case 212 and the negative electrode case 214 and that a material other than the solid electrolyte may be employed as the separator 230. With the exception of the above-described difference, the power storage cell 112 described with reference to FIG. 3 may have a constitution similar to that of the power storage cell 112 described with reference to FIG. 2.

The well-known electrolytic solution or gel electrolyte may be used as the liquid or gel-like electrolyte 350. The well-known separator may be used as the separator 230.

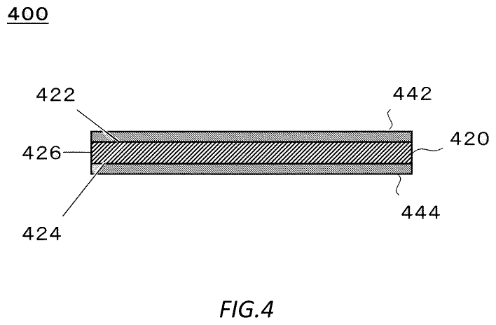

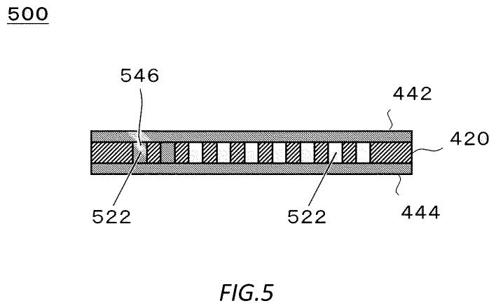

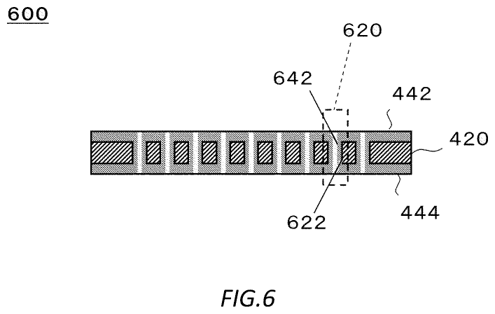

The detail of the positive electrode current collector 222 is described with reference to FIG. 4, FIG. 5, and FIG. 6. As described above, the negative electrode current collector 242 may also have a constitution similar to that of the positive electrode current collector 222. FIG. 4 schematically illustrates the cross-sectional view of the current collector 400 as one example of the positive electrode current collector 222. FIG. 5 schematically illustrates one example of the cross-sectional view of the current collector 500 as one example of the positive electrode current collector 222. FIG. 6 schematically illustrates one example of the cross-sectional view of the current collector 600 as one example of the positive electrode current collector 222.

As illustrated in FIG. 4, the current collector 400 includes a support layer 420, an electrically conductive layer 442, and an electrically conductive layer 444. In the present embodiment, the support layer 420 has a first planer surface 422, a second planer surface 424, and a side surface 426. In the present embodiment, the electrically conductive layer 442 is arranged on the first planer surface 422 of the support layer 420. The electrically conductive layer 444 is arranged on the second planer surface 424 of the support layer 420.

In the present embodiment, the support layer 420 supports the electrically conductive layer 442 and the electrically conductive layer 444. In this way, the breakage of the electrically conductive layer 442 and the electrically conductive layer 444 is suppressed. The density of the support layer 420 is lower than the density of the electrically conductive layer 442 or the electrically conductive layer 444. For example, the support layer 420 is constituted of a material with a density lower than the densities of the electrically conductive layer 442 or the electrically conductive layer 444. The support layer 420 may be a sheet-shaped resin material.

The resin material may be a thermoplastic resin or may be a thermosetting resin. The support layer 420 may be constituted of a single type of resin material or may include a plurality of types of resin material. As described above, if a part of a plurality of stacked current collectors 400 is welded, it is preferable that the resin material mainly includes thermoplastic resin or is substantially constituted of thermoplastic resin. In this way, for example, the support layer is heated before welding so that the fluidity of the support layer improves. In addition, if the support layer 420 mainly includes the thermoplastic resin or if the support layer 420 is substantially constituted of the thermoplastic resin, the plurality of current collectors 400 are welded more firmly, compared to if the support layer 420 mainly includes the thermosetting resin or if the support layer 420 is substantially constituted of the thermosetting resin. In this way, a stack with an excellent intensity of the welding portion and a low electrical resistance of the welding portion may be fabricated.

The electrical conductivity of the support layer 420 is not particularly limited but the electrical conductivity of the support layer 420 may be lower than the electrical conductivity of the electrically conductive layer 442 or the electrically conductive layer 444. The thickness of the support layer 420 is not particularly limited but the thickness of the support layer 420 may be larger than the thickness of the electrically conductive layer 442 or the electrically conductive layer 444. As the thickness of the support layer 420 increases, the mass of the support layer 420 increases. Therefore, if the support layer 420 is a sheet-shaped resin material, the thickness of the support layer 420 may be 10 μm or less, preferably 7 μm or less, or more preferably 5 μm or less.

In the present embodiment, the electrically conductive layer 442 and the electrically conductive layer 444 include an electrically conductive material. The electrically conductive material may be a material with a resistivity of 8.0×10⁻⁸ [Ω·m] or more. The electrically conductive material may be a metal. Examples of the above-described metal include aluminum, stainless steel, nickel, an alloy thereof, or the like. Examples of stainless steel include SUS-430, SUS-304, or the like. The electrically conductive material may be aluminum.

The thickness (in the figure, indicated as the length in the vertical direction) of the electrically conductive layer 442 and/or the electrically conductive layer 444 may be from 0.05 μm to 7 μm. The thickness of the electrically conductive layer 442 and/or the electrically conductive layer 444 may be from 0.05 μm to 5 μm, may be from 0.1 μm to 3 μm, may be from 0.1 μm to 2 μm, or may be from 0.5 μm to 1 μm. The thickness of the electrically conductive layer 442 and/or the electrically conductive layer 444 may be from 0.05 μm to 4 μm, may be from 0.05 μm to 3 μm, may be from 0.05 μm to 2 μm, or may be from 0.05 μm to 1 μm. The thickness of the electrically conductive layer 442 and/or the electrically conductive layer 444 is preferably from 0.1 μm to 5 μm and more preferably from 0.1 μm to 1 μm. Because commercially available aluminum foil, even relatively thin aluminum foil, has a thickness ranging from 6 to 10 μm, when the current collector 400 includes the electrically conductive layer 442 and/or the electrically conductive layer 444 having a thickness of 5 μm or less, the energy density per unit mass of the power storage cell [Wh/kg-power storage cell] improves compared to when the commercially available aluminum foil is used as the electrically conductive layer 442 and/or the electrically conductive layer 444.

At least one of the electrically conductive layer 442 and/or the electrically conductive layer 444 may be layer-shaped or foil-shaped aluminum having the above-described thickness. The layer-shaped or foil-shaped aluminum may be arranged on the surface of the support layer 420 through adhesion or may be formed on the surface of the support layer 420 through the vapor deposition method, deposition method, or the like.

If the thickness of the electrically conductive layer 442 and/or the electrically conductive layer 444 is 7 μm or less, the mass energy density of the power storage cell 112 improves. If the thickness of the electrically conductive layer 442 and/or the electrically conductive layer 444 is 5 μm or less, the mass energy density of the power storage cell 112 further improves. If the thickness of the electrically conductive layer 442 and/or the electrically conductive layer 444 is 1 μm or less, the mass energy density of the power storage cell 112 significantly improves. In general, when the thickness of the electrically conductive layer is 0.1 μm or less or less than 0.1 μm, the thickness of the electrically conductive layer 442 and/or the electrically conductive layer 444 likely causes breakage. However, the electrically conductive layer 442 and the electrically conductive layer 444 according to the present embodiment are supported by the support layer 420. Therefore, even when the thickness of the electrically conductive layer 442 and/or the electrically conductive layer 444 is approximately 0.05 to 0.1 μm, the breakage of the electrically conductive layer 442 and/or the electrically conductive layer 444 may be prevented.

When the support layer 420 is a resin material, the resistance to fracture of the electrically conductive layer 442 and the electrically conductive layer 444 during the above-described securing process is approximately the same as the resistance to fracture of the current collector 400 during the above-described securing process. The degree of resistance to fracture of the current collector 400 is determined through, for example, the tensile test of the sample cut from the current collector 400 into a strip shape including the support layer 420, the electrically conductive layer 442, and the electrically conductive layer 444. It is noted that when a part of the electrically conductive layer 442 and the electrically conductive layer 444 is fractured during the securing process, the electrical resistance of the electrically conductive layer 442 and the electrically conductive layer 444 may increase compared to before the securing process is performed.

As disclosed in, for example, “Test Machine Academia” (KEYENCE CORPORATION [online] https://www.keyence.co.jp/ss/products/recorder/testing-machine/material/tension.jsp (Apr. 6, 2022)), the size and shape of the sample have the strip-like overall shape with a width of 20 mm by a length of 100 mm and have a tapered region with a length of 40 mm at the center. The tapered region has a narrow region with a width of 10 mm by a length of 20 mm at the center. One end of the tapered region is coupled to one end of the narrow region and the other end of the tapered region is coupled to the other end of the narrow region.

For example, the tensile test is performed according to IPC-TM-650 or in accordance with IPC-TM-650. Specifically, the tensile strength of the sample is measured by attaching fixtures to both ends of the sample and pulling the sample upward and downward. The tensile speed is set to, for example, 2 inch/min (50.8 mm/min). The tensile strength in the above-described condition is sometimes denoted as, for example, Ts(50). The numerical value in the above-described bracket indicates the tensile speed.

The tensile strength Ts(50) of the above-described sample may be 360 MPa or more. The tensile strength Ts(50) may be 450 MPa or more.

As illustrated in FIG. 5, the current collector 500 is different from the current collector 400 described with reference to FIG. 4 in that the plurality of through-holes 522 are formed in the support layer 420. With the exception of the above-described difference, the current collector 500 may have a constitution similar to that of the current collector 400.

If a mere metal foil is used as the current collector, the metal foil bends during the formation of the through-holes in the current collector, sometimes making it difficult to form the through-holes. Therefore, in particular, if the active material layer is formed on both faces of the metal foil, it is difficult to form the through-holes in the current collector. In contrast, according to the present embodiment, since the electrically conductive layer is supported by a support layer such as a resin sheet, the current collector is relatively unlikely to bend even with the through-holes formed in the current collector.

According to the present embodiment, a part of the plurality of through-holes 522 is filled with the electrically conductive material 546. The electrically conductive material 546 electrically connects the electrically conductive layer 442 and the electrically conductive layer 444.

The circular equivalent bore (sometimes referred to as a circular equivalent diameter) of each of the plurality of through-holes 522 may be from 15 μm to 150 μm. The interval of the two adjacent through-holes 522 may be from 30 μm to 250 μm.

If the circular equivalent bore of the through-hole 522 is smaller than 15 μm, when the electrically conductive layer for electrically connecting the electrically conductive layer 442 and the electrically conductive layer 444 (sometimes referred to as an internal electrically conductive layer) is formed on the inner wall surface of the through-hole 522, the thickness of the electrically conductive layer formed on the inner wall surface is small and the electrical resistance of the electrically conductive layer is high. On the other hand, if the circular equivalent bore of the through-hole 522 is greater than 150 μm, when the electrically conductive layer for electrically connecting the electrically conductive layer 442 and the electrically conductive layer 444 is formed on the inner wall surface of the through-hole 522, the total amount of the electrically conductive layer is small and the electrical resistance of the electrically conductive layer 442 and the electrically conductive layer 444 is high. In addition, if the circular equivalent bore of the through-hole 522 is greater than 150 μm, the intensity of the current collector 500 is likely insufficient.

The circular equivalent bore of each of the plurality of through-holes 522 (sometimes referred to as a circular equivalent diameter) may be from 15 μm to 150 μm, may be from 15 μm to 50 μm, or may be from 15 to 35 μm. The circular equivalent bore of the through-hole 522 that is not filled with the electrically conductive material 546 may be from 15 μm to 50 μm or may be from 15 to 35 μm. The circular equivalent bore of the through-hole 522 that is filled with the electrically conductive material 546 is not particularly limited. In this way, the weight reduction of the current collector 500 may be achieved while preventing the fracture of the electrically conductive layer 442 and the electrically conductive layer 444.

The ratio of the total area of the plurality of through-holes 522 in one face of the current collector 500 to the area of the profile of the one face of the current collector 500 may be 30% or more. The ratio of the total area of the through-hole 522 that is not filled with the electrically conductive material 546 in one face of the current collector 500 to the area of the profile of the one face of the current collector 500 may be 30% or more. In this way, the weight reduction of the current collector 500 may be achieved while preventing the fracture of the electrically conductive layer 442 and the electrically conductive layer 444.

As illustrated in FIG. 6, the current collector 600 is different from the current collector 500 described with reference to FIG. 5 in that the plurality of through-holes 620 extending through the support layer 420, the electrically conductive layer 442, and the electrically conductive layer 444 are formed. With the exception of the above-described difference, the current collector 600 may have a constitution similar to that of the current collector 500.

In the present embodiment, the electrically conductive layer 642 is formed on the surface of the inner wall portion 622 of at least a part of the plurality of through-holes 620. The electrically conductive layer 642 may electrically connect the electrically conductive layer 442 and the electrically conductive layer 444.

In the present embodiment, the electrically conductive layer 642 includes the electrically conductive material. The electrically conductive material may be a metal. Examples of the above-described metal include aluminum, stainless steel, nickel, or an alloy thereof, or the like. Examples of stainless steel include SUS-430, SUS-304, or the like. The electrically conductive material may be aluminum.

The electrically conductive layer 642 may have a plurality of layers with different main components. The electrically conductive layer 642 may have three or more layers with different main components. The electrically conductive layer 642 includes, for example, an auxiliary layer, a target layer, and a protective layer. For example, a first layer with nickel as the main component is formed on the surface of the inner wall portion 622 of the through-hole 620, a second layer with copper as the main component is formed on the first layer, and chromate coating is formed on the second layer. The thickness of the first layer may be approximately 0.1 μm, the thickness of the second layer may be approximately 1 μm, and the thickness of the chromate coating may be approximately 0.3 μm.

The current collector 400 may be one example of the sheet material. The current collector 400 may be one example of the first sheet material, the second sheet material, or the third sheet material. The support layer 420 may be one example of the support layer. The electrically conductive layer 442 may be one example of one of the first metal layers and the second metal layer. The electrically conductive layer 444 may be one example of the other of the first metal layer and the second metal layer.

The current collector 500 may be one example of the sheet material. The current collector 500 may be one example of the first sheet material, the second sheet material, or the third sheet material.

The current collector 600 may be one example of the sheet material. The current collector 600 may be one example of the first sheet material, the second sheet material, or the third sheet material. The inner wall portion 622 may be one example of the inner wall of the through-hole. The electrically conductive layer 642 may be one example of the electrically conductive layer arranged on the inner wall of the through-hole. The electrically conductive layer 642 may be one example of the internal electrically conductive layer.

### (One Example of Another Embodiment)

In the present embodiment, the details of the current collector 400, the current collector 500, and the current collector 600 are described by using an example in which if a part of the plurality of stacked current collectors is welded, the support layer 420 mainly includes thermoplastic resin or is substantially constituted of thermosetting resin. However, the current collector 400, the current collector 500, and the current collector 600 are not limited to the present embodiment.

In another embodiment, if the electrically conductive layer 442 and the electrically conductive layer 444 arranged on both faces of the support layer 420 are electrically connected, the support layer 420 may mainly include thermosetting resin or may be substantially constituted of thermosetting resin. In particular, according to the current collector 500, the inside of at least a part of the plurality of through-holes 522 is filled with the electrically conductive material 546. Similarly, according to the current collector 600, the electrically conductive layer 642 is formed inside at least a part of the plurality of through-holes 620. Therefore, a part of the plurality of stacked current collectors may be integrated through welding without the electrically conductive layer 442 and the electrically conductive layer 444 of the single current collector coming close to or coming in contact with each other. In addition, the support layer is heated before welding so that the fluidity of the support layer decreases. In this way, the support layer is prevented from being extruded to the surroundings of the welded point and, as a result, the volume expansion of the surroundings of the welded point may be suppressed.

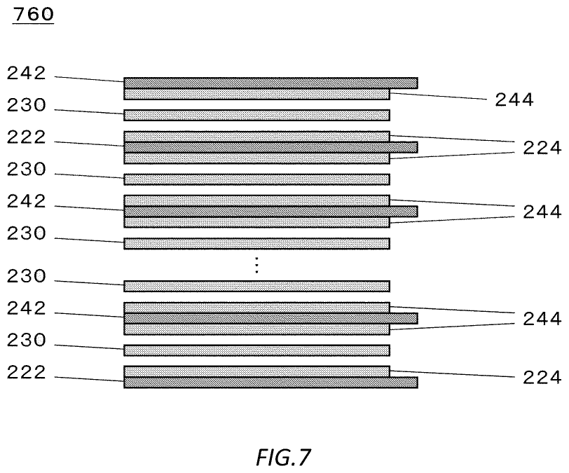

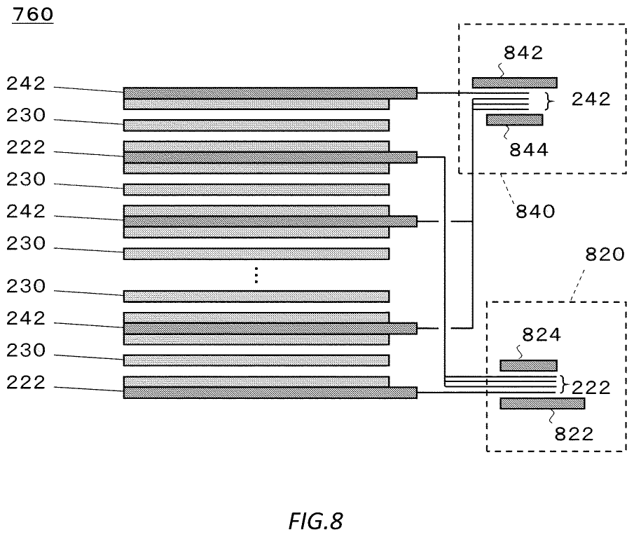

The detail of the stack structure 760 as another example of the electrode structure is described with reference to FIG. 7 and FIG. 8. FIG. 7 schematically illustrates one example of the cross-section of the stack structure 760. FIG. 8 schematically illustrates one example of the electrical connection relationship between the electrodes of the stack structure 760.

In an embodiment described with reference to FIG. 2, the detail of the structure constituting a part of the battery (sometimes referred to as an electrode structure) is described by using an example in which the positive electrode 220, the separator 230, and the negative electrode 240 are stacked in this sequence in the structure 260. However, the electrode structure is not limited to the structure 260. The stack structure 760 is different from the structure 260 in that it includes the plurality of positive electrodes 220, the plurality of separators 230, and the plurality of negative electrodes 240. With the exception of the above-described difference, the stack structure 760 may have a constitution similar to that of the structure 260.

As illustrated in FIG. 7, in the present embodiment, the stack structure 760 includes one or more positive electrodes 220, one or more negative electrodes 240, and one or more separators 230 arranged between each of the one or more positive electrodes 220 and each of the one or more negative electrodes 240. As illustrated in FIG. 7, the stack structure 760 includes the plurality of positive electrodes 220, the plurality of negative electrodes 240, and the plurality of separators 230 arranged between each of the plurality of positive electrodes 220 and each of the plurality of negative electrodes 240.

With the exception of the positive electrode 220 arranged at the outermost part of the stack structure 760, each of the plurality of positive electrodes 220 has a positive electrode active material layer 224 arranged on both faces of the positive electrode current collector 222. The positive electrode 220 arranged at the outermost part of the stack structure 760 has the positive electrode active material layer 224 arranged on one face of the positive electrode current collector 222.

With the exception of the negative electrode 240 arranged at the outermost part of the stack structure 760, each of the plurality of negative electrodes 240 has a negative electrode active material layer 244 arranged on both faces of the negative electrode current collector 242. The negative electrode 240 arranged at the outermost part of the stack structure 760 has a negative electrode active material layer 244 arranged on one face of the negative electrode current collector 242.

In the present embodiment, the positive electrode active material layer 224 is arranged in a part of the positive electrode current collector 222. For example, in the vicinity of at least one end of the positive electrode current collector 222, the positive electrode active material layer 224 is not formed on at least one face of the positive electrode current collector 222. For example, the plurality of positive electrodes 220 are stacked such that the ends on the side at which the positive electrode active material layers 224 are not formed are oriented in approximately the same direction.

In the present embodiment, the negative electrode active material layer 244 is arranged in a part of the negative electrode current collector 242. For example, in the vicinity of at least one end of the negative electrode current collector 242, the negative electrode active material layer 244 is not formed on at least one face of the negative electrode current collector 242. For example, the plurality of negative electrodes 240 are stacked such that the ends on the side at which the negative electrode active material layers 244 are not formed are oriented in approximately the same direction.

As illustrated in FIG. 8, the stack structure 760 includes a positive electrode connection 820 that electrically connects each of the plurality of positive electrodes 220. According to the present embodiment, the positive electrode connection 820 has a lead 822 and a sub-lead 824 that sandwich and support a part of the plurality of positive electrodes 220. In this way, the durability at the bonding point of the plurality of positive electrodes 220 improves.

In the present embodiment, the lead 822 and the sub-lead 824 sandwich and support the end of the positive electrode current collector 222 of each of the plurality of positive electrodes 220 and/or the vicinity of the end. As described above, in the vicinity of at least one end of each of the plurality of positive electrodes 220, the positive electrode active material layer 224 is not formed. The lead 822 and the sub-lead 824 are arranged to sandwich the plurality of stacked positive electrode current collectors 222. It is noted that, in another embodiment, the sub-lead 824 may not be used.

In the positive electrode connection 820, the plurality of positive electrodes 220 may be physically bonded by welding. For example, the plurality of stacked positive electrode current collectors 222 are physically bonded by welding so that the ends of the plurality of positive electrode current collectors 222 and/or the vicinity of the end are integrated. In this way, the plurality of positive electrodes 220 are physically bonded. At the end of the plurality of positive electrode current collectors 222 and/or the vicinity of the end, the plurality of positive electrode current collectors 222 may be integrated with the lead 822 and/or the sub-lead 824. Examples of welding methods include ultrasonic welding, resistance welding, laser welding, or the like.

In the present embodiment, the detail of the stack structure 760 is described by using an example in which the region positioned in the vicinity of the end of the positive electrode current collector 222 of each of the plurality of positive electrodes 220 (sometimes referred to as the welded region) are welded so that the positive electrode current collector 222 of each of the plurality of the positive electrodes 220 is physically bonded. It is noted that, in another embodiment, the welded region may be arranged to include the end of the positive electrode current collector 222 of each of the plurality of positive electrodes 220.

For example, as described with reference to FIG. 4, FIG. 5, or FIG. 6, each of the plurality of positive electrode current collectors 222 has the support layer 420, and the electrically conductive layer 442 and the electrically conductive layer 444 formed on both faces of the support layer 420. For example, the electrically conductive layer 442 and the electrically conductive layer 444 are electrically connected via the electrically conductive material 546 and/or the electrically conductive layer 642. The composition or material of the support layer 420 may be the same or different among each of the plurality of positive electrode current collectors 222. The composition or material of the support layer 420 of one positive electrode current collector 222 may be the same as or different from the composition or material of the support layer 420 of the other positive electrode current collector 222.

In the present embodiment, for example, the welded region is arranged in at least a part of a region that is in the vicinity of the end of the plurality of positive electrode current collectors 222 and is sandwiched by the lead 822 and the sub-lead 824. The plane dimension of the sub-lead 824 may be greater than the plane dimension of the welded region. The plane dimension of the lead 822 may be greater than the plane dimension of the sub-lead 824.

For example, the lead 822 is constituted of a board-shaped electrically conductive material. The thickness of the lead 822 may be from 10 to 300 μm, preferably from 30 to 200 μm, and more preferably from 50 to 100 μm.

The material of the sub-lead 824 is not particularly limited. For example, the sub-lead 824 is constituted of aluminum, nickel, stainless steel, and the alloy thereof. The sub-lead 824 may be constituted of a resin material such as polypropylene, polyimide, or the like. The thickness of the sub-lead 824 may be from 10 to 300 μm, preferably from 30 to 200 μm, and more preferably from 50 to 100 μm.

Similarly, the stack structure 760 includes a negative electrode connection 840 electrically connecting each of the plurality of negative electrodes 240. According to the present embodiment, the negative electrode connection 840 has the lead 842 and the sub-lead 844 supporting and sandwiching a part of the plurality of positive electrodes 220. In this way, the durability of the bonding points of the plurality of negative electrodes 240 improves.

In the present embodiment, the lead 842 and the sub-lead 844 support and sandwich the end of the negative electrode current collector 242 of each of the plurality of negative electrodes 240 and/or the vicinity of the end. As described above, the negative electrode active material layer 244 is not formed in the vicinity of at least one end of each of the plurality of negative electrodes 240. The lead 842 and the sub-lead 844 are arranged to sandwich the plurality of stacked negative electrode current collectors 242. It is noted that, in another embodiment, the sub-lead 844 may not be used.

In the negative electrode connection 840, the plurality of negative electrodes 240 may be physically bonded by welding. For example, the end of the plurality of negative electrode current collectors 242 and/or the vicinity of the end are integrated by physically bonding the plurality of stacked negative electrode current collectors 242 by welding. In this way, the plurality of negative electrodes 240 are physically bonded. At the end of the plurality of negative electrode current collectors 242 and/or the vicinity of the end, the plurality of negative electrode current collectors 242, the lead 842, and/or the sub-lead 844 may be integrated. Examples of welding methods include ultrasonic welding, resistance welding, laser welding, or the like.

According to the present embodiment, the detail of the stack structure 760 is described by using an example in which the negative electrode current collector 242 of each of the plurality of negative electrodes 240 is physically bonded by welding the region positioned in the vicinity of the end of the negative electrode current collector 242 of each of the plurality of negative electrodes 240 (sometimes referred to as a welded region). It is noted that, in another embodiment, the welded region may be arranged to include the end of the negative electrode current collector 242 of each of the plurality of negative electrodes 240.

For example, as described with reference to FIG. 4, FIG. 5, or FIG. 6, each of the plurality of negative electrode current collectors 242 has the support layer 420, and the electrically conductive layer 442 and the electrically conductive layer 444 formed on both faces of the support layer 420. For example, the electrically conductive layer 442 and the electrically conductive layer 444 are electrically connected via the electrically conductive material 546 and/or the electrically conductive layer 642. The composition or material of the support layer 420 may be the same or different among each of the plurality of negative electrode current collectors 242. The composition or material of the support layer 420 of one negative electrode current collector 242 may be the same as or different from the composition or material of the support layer 420 of the other negative electrode current collector 242.

In the present embodiment, for example, the welded region is arranged in at least a part of a region that is in the vicinity of the ends of the plurality of the negative electrode current collectors 242 and is sandwiched by the lead 842 and the sub-lead 844. The plane dimension of the sub-lead 844 may be greater than the plane dimension of the welded region. The plane dimension of the lead 842 may be greater than the plane dimension of the sub-lead 844.

For example, the lead 842 is constituted of a board-shaped electrically conductive material. The thickness of the lead 842 may be from 10 to 300 μm, preferably from 30 to 200 μm, and more preferably from 50 to 100 μm.

The material of the sub-lead 844 is not particularly limited. For example, the sub-lead 844 is constituted of aluminum, nickel, stainless steel, and the alloy thereof. The sub-lead 844 may be constituted of a resin material such as polypropylene, polyimide, or the like. The thickness of the sub-lead 844 may be from 10 to 300 μm, preferably from 30 to 200 μm, and more preferably from 50 to 100 μm.

The lead 822 and the sub-lead 824 may be one example of the positive electrode supporting unit. The lead 842 and the sub-lead 844 may be one example of the negative electrode supporting unit.

The lead 822 may be one example of the first support member. The sub-lead 824 may be one example of the second support member. The lead 842 may be one example of the first support member. The sub-lead 844 may be one example of the second support member. The stack structure 760 may be one example of the electrode structure. The plurality of positive electrode current collectors 222 included in the stack structure 760 may be one example of the plurality of stacked sheet materials. The plurality of negative electrode current collectors 242 included in the stack structure 760 may be one example of the plurality of stacked sheet materials.

The positive electrode current collector 222 contacting the lead 822 among the plurality of stacked positive electrode current collectors 222 in the positive electrode connection 820 may be one example of the first sheet material or the third sheet material. The positive electrode current collector 222 contacting the sub-lead 824 among the plurality of stacked positive electrode current collectors 222 in the positive electrode connection 820 may be one example of the second sheet material or the third sheet material. The negative electrode current collector 242 contacting the lead 842 among the plurality of stacked negative electrode current collector 242 in the negative electrode connection 840 may be one example of the first sheet material or the third sheet material. The negative electrode current collector 242 contacting the sub-lead 844 among the plurality of stacked negative electrode current collector 242 in the negative electrode connection 840 may be one example of the second sheet material or the third sheet material.

The plurality of positive electrodes 220 included in the stack structure 760 may be one example of the first electrode and the second electrode and the plurality of negative electrodes 240 included in the stack structure 760 may be one example of the third electrode and the fourth electrode. The plurality of positive electrodes 220 included in the stack structure 760 is one example of the third electrode and the fourth electrode and the plurality of negative electrodes 240 included in the stack structure 760 may be one example of the first electrode and the second electrode. The plurality of separators 230 included in the stack structure 760 may be one example of the first separator, the second separator, and the third separator.

### (One Example of Another Embodiment)

In the present embodiment, the detail of the stack structure 760 is described by using an example in which the stack structure 760 includes the positive electrode connection 820 and the negative electrode connection 840. However, the stack structure 760 is not limited to the present embodiment. In another embodiment, the stack structure 760 may include at least one of the positive electrode connection 820 or the negative electrode connection 840.

In the present embodiment, the detail of the positive electrode connection 820 is described by using an example in which the plurality of positive electrode current collectors 222 are supported by the lead 822 and the sub-lead 824 in the positive electrode connection 820. However, the positive electrode connection 820 is not limited to the present embodiment. In another embodiment, the positive electrode connection 820 may not include the sub-lead 824. In this case, the plurality of positive electrode current collectors 222 are supported by the lead 822.

In the present embodiment, the detail of the negative electrode connection 840 is described by using an example in which the plurality of negative electrode current collectors 242 are supported by the lead 842 and the sub-lead 844 in the negative electrode connection 840. However, the negative electrode connection 840 is not limited to the present embodiment. In another embodiment, the negative electrode connection 840 may not include the sub-lead 844. In this case, the plurality of negative electrode current collectors 242 are supported by the lead 842.

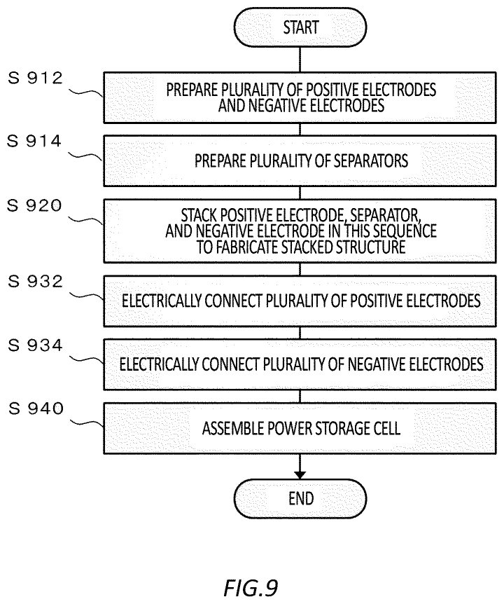

FIG. 9 schematically illustrates one example of the producing method for the power storage cell 112. In the present embodiment, the method for producing the power storage cell 112 including the stack structure 760 is described. According to the present embodiment, at first, at step 912 (step is sometimes simply referred to as S), the plurality of positive electrodes 220 and the plurality of negative electrodes 240 are prepared. The detail of the method for preparing the positive electrode 220 or the negative electrode 240 is described below. In addition, at S914, the plurality of separators 230 are prepared. Then, at S920, the positive electrode 220, the separator 230, and the negative electrode 240 are stacked in this sequence. In this way, the stack structure 760 is fabricated.

Then, at 932, the plurality of positive electrodes 220 of the stack structure 760 are electrically connected. In addition, at S934, the plurality of negative electrodes 240 of the stack structure 760 are electrically connected. Subsequently, at S940, the stack structure 760 is accommodated inside the positive electrode case 212 and the negative electrode case 214 and the power storage cell 112 is assembled.

The plurality of positive electrodes 220 prepared at S912 may be one example of the first electrode and the second electrode and the plurality of negative electrodes 240 prepared at S912 may be one example of the third electrode and the fourth electrode. The plurality of positive electrodes 220 prepared at S912 may be one example of the third electrode and the fourth electrode and the plurality of negative electrodes 240 prepared at S912 may be one example of the first electrode and the second electrode. The plurality of separators 230 prepared at S914 may be one example of the first separator, the second separator, and the third separator. The stack structure 760 may be one example of the electrode structure in which the first electrode, the first separator, the third electrode, the second separator, the second electrode, the third separator, and the fourth negative electrode are stacked in this sequence.

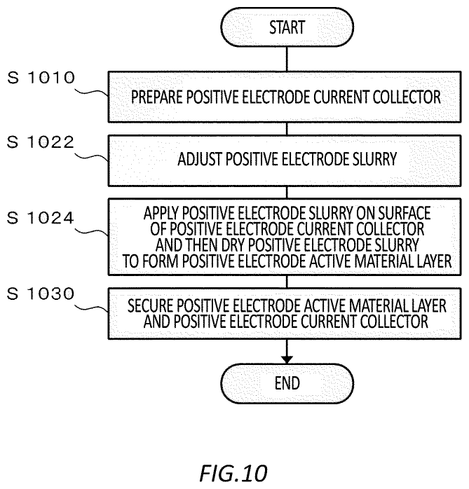

FIG. 10 schematically illustrates one example of the producing method of the positive electrode 220. According to the present embodiment, at first, at S1010, the positive electrode current collector 222 is prepared. Then, at S1022, the positive electrode slurry including the positive electrode active material and the solvent is adjusted. Then, at S1024, the positive electrode slurry is applied on the surface of the positive electrode current collector 222. In addition, the positive electrode slurry is dried. In this way, the positive electrode active material layer 224 is formed on the surface of the positive electrode current collector 222.

Then, at S1030, the positive electrode active material layer 224 and the positive electrode current collector 222 are secured. More specifically, the positive electrode active material layer 224 and the positive electrode current collector 222 are secured by applying pressure to the stacked positive electrode active material layer 224 and positive electrode current collector 222.

In one embodiment, the pressure in the securing process is set or adjusted so that (i) the change ratio of the electrical resistance (the specific resistance) of the current collector before and after the pressure is applied to the active material layer and the current collector is 50% or less or (ii) the absolute value of the difference in the electrical resistance (the specific resistance) of the current collector before and after the pressure is applied to the active material layer and the current collector is 1 [Ω] or less. The pressure in the securing process may be set or adjusted so that the above-described absolute value of the difference is less than 1 [Ω]. The pressure in the securing process is preferably set or adjusted so that the above-described absolute value of the difference is 500 m [Ω] or less and is more preferably set or adjusted so that the above-described absolute value of the difference is 100 m [Ω] or less. In this way, the electrically conductive layer of the current collector is prevented from being fractured. For example, the electrical resistance of the above-described current collector may be measured in a 4-terminal, 4-probe manner using a low resistivity meter (Nittoseiko Analytech Co., Ltd., Loresta-GX MCP-T 700).

In another embodiment, the pressure in the securing process is set or adjusted so that the value obtained by subtracting, from (i) the value of the second voltage measured by applying current to the electrically conductive layer of the current collector after the pressure is applied, (ii) the value of the first voltage measured by applying current to the electrically conductive layer of the current collector before the pressure is applied is less than 100 mV. In this way, the electrically conductive layer of the current collector is prevented from being fractured. The above-described first voltage and second voltage are measured by a low resistivity meter having, for example, a measurement function and output function for a voltage value. For example, the above-described first voltage and second voltage may be measured in a 4-terminal, 4-probe manner using a low resistivity meter (Nittoseiko Analytech Co., Ltd., Loresta-GX MCP-T 700).

In another embodiment, the pressure in the securing process is set or adjusted so that the porosity of the active material layer is from 20 to 40% after the pressure is applied, which prevents the electrically conductive layer of the current collector from being fractured.

For example, if pressure is applied to the positive electrode active material layer 224 and the positive electrode current collector 222 using a roll press, the roll press is controlled so that the linear load applied to the positive electrode active material layer 224 and the positive electrode current collector 222 is from 1.0 kgf/cm to 200 kgf/cm. The roll press may be controlled so that the above-described linear load is from 2 kgf/cm to 150 kgf/cm or the roll press may be controlled so that the above-described linear load is from 10 kgf/cm to 100 kgf/cm. In this way, the positive electrode current collector 222 having the above-described property is fabricated.

### (The Procedure to Physically Bond the Plurality of Electrodes)

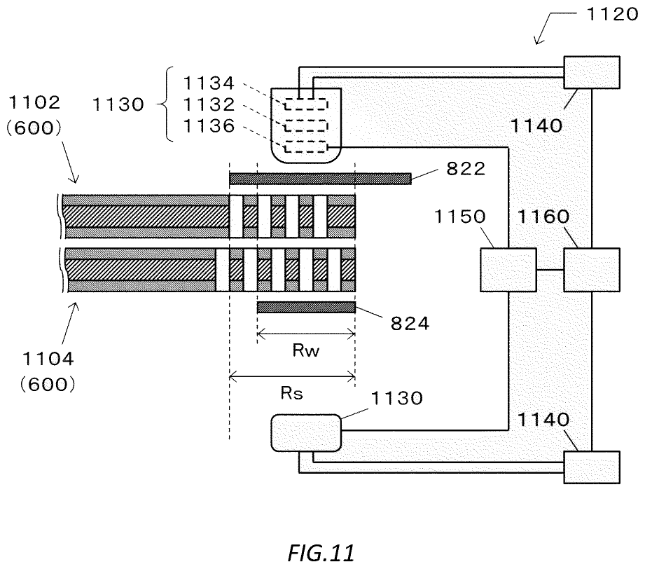

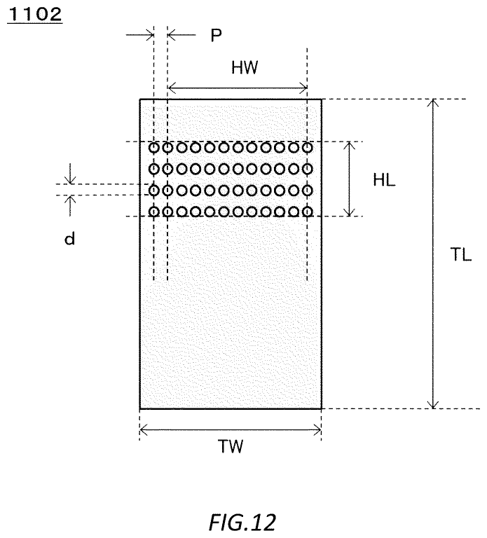

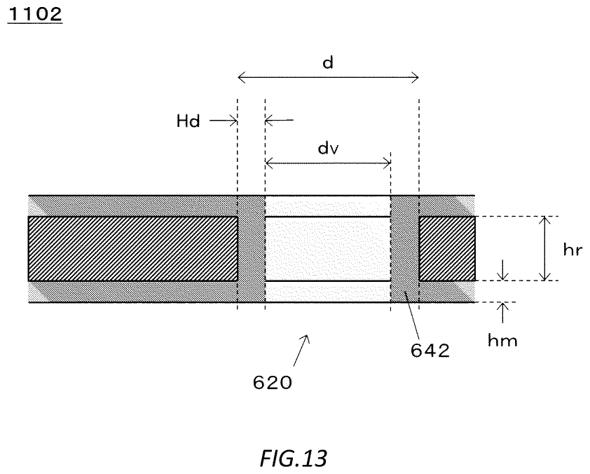

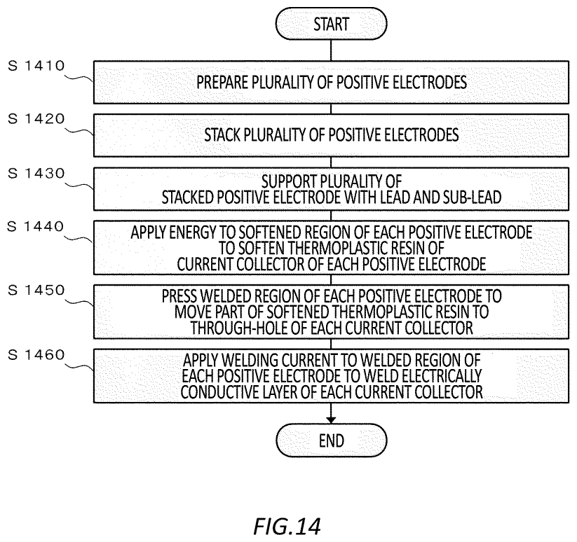

One example of the procedure for physically bonding the plurality of electrodes is described with reference to FIG. 11, FIG. 12, FIG. 13, and FIG. 14. For example, as described with reference to FIG. 8 and FIG. 9, according to one embodiment of the stack structure 760, the plurality of positive electrodes 220 are physically bonded by welding in the positive electrode connection 820. For example, the positive electrode current collector 222 of each of the plurality of positive electrodes 220 is physically bonded by welding. According to one embodiment of the stack structure 760, the plurality of negative electrodes 240 are physically bonded by welding in the negative electrode connection 840. For example, the negative electrode current collector 242 of each of the plurality of negative electrodes 240 is physically bonded by welding.

In the present embodiment, to facilitate the understanding of the procedure for physically bonding a plurality of electrodes, the detail of the procedure for physically bonding the plurality of electrodes is described by using an example in which a part of the two positive electrodes 220 are bonded by welding using the welding device 1120. It is noted that the number of electrodes bonded by welding is not limited to two. In another embodiment, three or more electrodes may be bonded by welding.

In addition, in the present embodiment, to facilitate the understanding of the procedure for physically bonding a plurality of electrodes, the detail of the procedure for physically bonding a plurality of electrodes is described by using an example in which one of the positive electrodes 220 includes the current collector 1102 and the positive electrode active material layer 224 arranged on at least one face of the current collector 1102 and the other of the positive electrodes 220 includes the current collector 1104 and the positive electrode active material layer 224 arranged on at least one face of the current collector 1104. In the present embodiment, the detail of the procedure for physically bonding the plurality of electrodes is described by using an example in which the positive electrode active material layer 224 is not formed in the vicinity of the ends of the current collector 1102 and the current collector 1104.

FIG. 11 illustrates one example of the system configuration of the welding device 1120 with one example of the ends of the current collector 1102 and the current collector 1104 and/or the vicinity of the ends. One example of the welding procedure using the welding device 1120 is described with reference to FIG. 11. More specifically, with reference to FIG. 11, one example of the procedure for fabricating the positive electrode connection 820 is described in which the welding device 1120 welds a part of the vicinity of the ends of the current collector 1102 and the current collector 1104 while pressing the ends of the current collector 1102 and the current collector 1104 and the vicinity of the ends.

### (Welding Target)

In the present embodiment, the current collector 1102 and the current collector 1104, which are the targets of the welding process, have a constitution similar to that of the current collector 600 described with reference to FIG. 6. As described with reference to FIG. 6, the current collector 600 has the support layer 420, and the electrically conductive layer 442 and the electrically conductive layer 444 formed on both faces of the support layer 420. The plurality of through-holes 620 extending through the support layer 420, the electrically conductive layer 442, and the electrically conductive layer 444 are formed on the current collector 600. The shapes of the through-holes 620 are not particularly limited. The electrically conductive layer 642 that electrically connects the electrically conductive layer 442 and the electrically conductive layer 444 is formed on the surface of the inner wall portions 622 of at least a part of the plurality of through-holes 620.

In the present embodiment, the support layers 420 of the current collector 1102 and the current collector 1104 include a thermoplastic resin material (sometimes referred to as a thermoplastic resin). In the present embodiment, the support layers 420 of the current collector 1102 and the current collector 1104 may be resin layers substantially consisting of a thermoplastic resin material. The support layer 420 of the current collector 1102 and the current collector 1104 may be an insulating layer substantially consisting of a thermoplastic resin material.

According to the present embodiment, when energy is applied to the support layers 420 of the current collector 1102 and the current collector 1104, the temperature of the support layers 420 rises and the resin material included in the support layer 420 softens. When pressure is applied to the current collector 1102 and the current collector 1104 while the resin material included in the support layers 420 softens, the resin material may move inside the support layer 420. The type of the above-described energy is not particularly limited as long as it can increase the temperature of the resin material included in the support layer 420 and/or the support layer 420. The above-described energy may be thermal energy.

The thermoplastic resin material may be a resin material with a thermal shrinkage rate of 1% or less at 25° C. Examples of thermoplastic resin materials include PE, PET, PAN, PP, PPS, or the like.

The thickness of the support layers 420 of the current collector 1102 and the current collector 1104 may be from 0.5 μm to 20 μm. The thickness of the above-described support layer 420 is preferably from 1 μm to 10 μm and more preferably from 2 μm to 8 μm.

In the present embodiment, each electrically conductive layer 442 and electrically conductive layer 444 of the current collector 1102 and the current collector 1104 include a metal material. Each electrically conductive layer 442 and electrically conductive layer 444 of the current collector 1102 and the current collector 1104 may be a metal layer substantially consisting of a metal material. The metal layer substantially consisting of a metal material includes, for example, inevitable impurities. The metal material included in the electrically conductive layer 442 and the electrically conductive layer 444 may be a single metal or may be an alloy.

The thickness of the electrically conductive layer 442 and the electrically conductive layer 444 of the current collector 1102 and the current collector 1104 may be from 0.1 μm to 10 μm. The thickness of the above-described electrically conductive layer 442 and electrically conductive layer 444 is preferably from 0.1 μm to 5 μm and more preferably from 0.1 μm to 1 μm.

In the present embodiment, each electrically conductive layer 442 and electrically conductive layer 444 of the current collector 1102 and the current collector 1104 are electrically connected. Therefore, the welding current applied by the welding device 1120 to the electrically conductive layer 442 of the current collector 1102 flows through the electrically conductive layer 442 of the current collector 1102, the electrically conductive layer 442 of the current collector 1104, and the electrically conductive layer 444 of the current collector 1104.

The electrically conductive layer 442 and the electrically conductive layer 444 may be electrically connected in any aspect. In one embodiment, the electrically conductive member that electrically connects the electrically conductive layer 442 and the electrically conductive layer 444 is arranged on the side surface 426 of the support layer 420. In another embodiment, the electrically conductive member that electrically connects the electrically conductive layer 442 and the electrically conductive layer 444 is arranged inside the support layer 420.

In the present embodiment, the plurality of through-holes 620 extending through the support layer 420, the electrically conductive layer 442, and the electrically conductive layer 444 of the current collector 1102 are formed in a part of the current collector 1102. At least a part of the plurality of through-holes 620 is arranged in the above-described welded region (represented as Rw in FIG. 11). In this way, compared to the case where the through-holes or grooves or recesses are not formed on the welded region of the support layer 420, the amount of the resin material existing in the welded region of the support layer 420 decreases. As a result, the amount of the resin material displaced due to the welding of the electrically conductive layer 442 and the electrically conductive layer 444 decreases and the volume expansion of the surroundings of the welded region due to the welding is suppressed.

According to the present embodiment, the through-holes 620 are also formed in the electrically conductive layer 442 and the electrically conductive layer 444. In this way, the resin material displaced due to the welding of the electrically conductive layer 442 and the electrically conductive layer 444 can flow into the through-holes 620 arranged in the electrically conductive layer 442 and the electrically conductive layer 444. As a result, the volume expansion of the surroundings of the welded region due to the welding is suppressed.

At least a part of the plurality of through-holes 620 may be arranged in the region adjacent to the welded region (sometimes referred to as an adjacent region). As described above, due to the welding of the electrically conductive layer 442 and the electrically conductive layer 444, a part of the resin material existing in the welded region before welding is displaced and moves toward the adjacent region. According to the present embodiment, since the through-holes 620 are formed in the adjacent region, the resin material displaced due to the welding of the electrically conductive layer 442 and the electrically conductive layer 444 can flow into the through-holes 620 arranged in the adjacent region. As a result, the volume expansion of the surroundings of the welded region due to the welding is suppressed.

At least a part of the plurality of through-holes 620 may be arranged in a welded region and the region adjacent to the welded region. In this way, the volume expansion of the surroundings of the welded region due to the welding is further suppressed. The detail of the through-hole 620 is described below.

In the present embodiment, the electrically conductive layer 642 electrically connecting the electrically conductive layer 442 and the electrically conductive layer 444 is arranged on the surface of the inner wall portion 622 of at least a part of the plurality of through-holes 620. The type and structure of the material constituting the electrically conductive layer 642 is not particularly limited as long as it is the substance has electrical conductivity. The electrically conductive layer 642 may include the metal material. The electrically conductive layer 642 may be a metal layer substantially consisting of the metal material. The metal layer substantially consisting of a metal material includes, for example, inevitable impurities.

The metal material included in the electrically conductive layer 642 may be a single metal or may be an alloy. The metal material included in the electrically conductive layer 642 may be the same as or different from the metal material included in at least one of the electrically conductive layer 442 or the electrically conductive layer 444. Examples of the above-described metal material include copper, nickel, aluminum, stainless steel, the alloy thereof, or the like. Examples of stainless steel include SUS 304, SUS 430, or the like.

The electrically conductive layer 642 may include a plurality of layers. The plurality of layers may be each constituted of materials different from each other. For example, the electrically conductive layer 642 may include a layer for electrically connecting the electrically conductive layer 442 and the electrically conductive layer 444 (sometimes referred to as a target layer) and an auxiliary layer arranged between the inner wall portion 622 of the through-hole 620 and the target layer. The auxiliary layer may be formed to enhance the electrical conductivity of the target layer and/or improve the adhesion of the through-hole 620 and the target layer. A protective layer for protecting the target layer may be formed on the surface of the target layer. Examples of the protective layer include chromate coating, zinc coating, or the like.

The electrically conductive layer 642 may include the auxiliary layer, the target layer, and the protective layer. For example, a first layer with nickel as the main component is formed on the surface of the inner wall portion 622 of the through-hole 620, a second layer with copper as the main component is formed on the first layer, and chromate coating is formed on the second layer. The thickness of the first layer may be approximately 0.1 μm, the thickness of the second layer may be approximately 1 μm, and the thickness of the chromate coating may be approximately 0.3 μm.

As described above, the thickness of the electrically conductive layer 642 of the current collector 1102 and the current collector 1104 may be from 0 μm to 5 μm. The thickness of the above-described electrically conductive layer 642 is preferably from 0.1 μm to 3 μm and more preferably from 0.1 μm to 1 μm.

The electrically conductive layer 642 is formed by a well-known method. For example, the electrically conductive layer 642 is formed by electroless plating, deposition, or sputtering. The electrically conductive layer 642 may be formed by various secondary growth methods or may be formed by attaching a metal foil to the surface of the inner wall portion 622 of the through-hole 620.

Similarly, the plurality of through-holes 620 extending through the support layer 420, the electrically conductive layer 442, and the electrically conductive layer 444 of the current collector 1104 are formed in a part of the current collector 1104. The electrically conductive layer 642 electrically connecting the electrically conductive layer 442 and the electrically conductive layer 444 is arranged on the surface of the inner wall portion 622 of at least a part of the plurality of through-holes 620. The electrically conductive layer 642 of the current collector 1104 may have similar characteristics to the characteristics described in relation to the electrically conductive layer 642 of the current collector 1102.

### (Support Member)

As described above, since the electrically conductive layer 442 and the electrically conductive layer 444 according to the present embodiment is formed of the metal thin film, the intensity is relatively low. Therefore, according to the present embodiment, the current collector 1102 and the current collector 1104 are supported by using the lead 822 and the sub-lead 824 described with reference to FIG. 8. In the present embodiment, the lead 822 and the sub-lead 824 are arranged to sandwich the stacked current collector 1102 and current collector 1104. In this way, the fracture of the metal thin film during welding is prevented.

As described above, a member with electrical conductivity is used as the lead 822. On the other hand, a member with electrical conductivity or non-electrical conductivity is used as the sub-lead 824.

### (Welding Device)

In the present embodiment, the welding device 1120 includes a pair of welding heads 1130, a heating power supply 1140, a welding power supply 1150, and a controller 1160. In the present embodiment, the welding device 1120 includes a pair of heating power supplies 1140 for supplying electrical power to each of the pair of welding heads 1130. In the present embodiment, the welding head 1130 includes a position adjustment unit 1132, a heating unit 1134, and a welding unit 1136.

In the present embodiment, the welding head 1130 applies energy to the welding target. For example, the welding head 1130 heats the welding target. The welding head 1130 presses the welding target. In this way, the welding head 1130 can apply pressure to the welding target.

In the present embodiment, the position adjustment unit 1132 adjusts the position of the welding head 1130. For example, the position adjustment unit 1132 moves the welding head 1130 to the welded region of the welding target. For example, the position adjustment unit 1132 presses the welding head 1130 against the welded region of the welding target. In this way, the welding head 1130 presses the welded region of the welding target. As a result, pressure is applied to the welded region of the welding target.

In the present embodiment, the heating unit 1134 applies energy to the softened region of the welding target. In this way, the softened region of the welding target is heated. In the present embodiment, the welding unit 1136 applies current and/or voltage to the welded region of the welding target. In this way, the welded region of the welding target is welded.

In the present embodiment, the heating power supply 1140 supplies electrical power to the heating unit 1134. In the present embodiment, the welding power supply 1150 supplies electrical power to the position adjustment unit 1132 and the welding unit 1136. In the present embodiment, the controller 1160 controls the operation of each portion of the welding device 1120.

### (Welding Procedure)

Then, one example of a procedure to weld a part of the current collector 1102 and the current collector 1104 using the welding device 1120 is described. According to the present embodiment, at first, the current collector 1102 and the current collector 1104 to be the welding targets are prepared. In one embodiment, the current collector 1102 and the current collector 1104 having the above-described structure are fabricated. In another embodiment, the current collector 1102 and the current collector 1104 having the above-described structure are purchased.

Then, the current collector 1102 and the current collector 1104 are welded and the stack in which parts of the current collector 1102 and the current collector 1104 are bonded is fabricated. More specifically, at first, the current collector 1102 and the current collector 1104 are stacked. For example, the current collector 1102 and the current collector 1104 are stacked such that the side of the second planer surface 424 of the current collector 1102 and the side of the first planer surface 422 of the current collector 1104 are in contact with each other.

In one embodiment, the plurality of through-holes 620 of the current collector 1102 and the plurality of through-holes 620 of the current collector 1104 are aligned. In another embodiment, the plurality of through-holes 620 of the current collector 1102 and the plurality of through-holes 620 of the current collector 1104 are not aligned.

Then, the current collector 1102 and the current collector 1104 are reinforced by using the lead 822 and the sub-lead 824. For example, the current collector 1102 and the current collector 1104 as well as the lead 822 and the sub-lead 824 are installed on the work position of the welding device 1120 such that the lead 822 and the sub-lead 824 sandwich the welded regions of the current collector 1102 and the current collector 1104 or the regions of the surroundings thereof.

Then, the welded regions of the current collector 1102 and the current collector 1104 are determined. In addition, the region that includes the welded regions of the stacked current collector 1102 and current collector 1104 and is to be the target of the heat process (for example, the softened region represented as Rs in FIG. 11) is determined.

For example, the user of the welding device 1120 operates the welding device 1120 to input the positions of the welded region and the softened region into the welding device 1120. The controller 1160 of the welding device 1120 controls the position adjustment unit 1132 to move the welding head 1130 to any position of the softened regions of the current collector 1102 and the current collector 1104 (for example, the welded region). The controller 1160 of the welding device 1120 controls the position adjustment unit 1132 to bring the welding head 1130 into contact with the softened regions of the current collector 1102 and the current collector 1104.

Then, the resin material of the softened region is softened by applying energy to the region (sometimes referred to as a softened region) including the welded regions of the stacked current collector 1102 and current collector 1104. For example, the controller 1160 of the welding device 1120 controls the heating power supply 1140 to supply electrical power from the heating power supply 1140 to the heating unit 1134. In this way, the heating unit 1134 increases the temperature of the welding head 1130. As a result, thermal energy is applied from the welding head 1130 to the softened regions of the current collector 1102 and the current collector 1104.

As described above, in the present embodiment, the support layers 420 of the current collector 1102 and the current collector 1104 include thermoplastic resin. When thermal energy is applied to the softened regions of the current collector 1102 and the current collector 1104, the thermoplastic resin arranged in the softened region softens.

Then, the welded region arranged in at least a part of the softened region is pressed. For example, the controller 1160 of the welding device 1120 controls the position adjustment unit 1132 to press the welding head 1130 against the welded region.

For example, the controller 1160 controls the position adjustment unit 1132 to bring each electrically conductive layer 442 and electrically conductive layer 444 of the current collector 1102 and the current collector 1104 close to each other to a distance that allows welding. At this time, pressure is also applied to the thermoplastic resin arranged between the electrically conductive layer 442 and the electrically conductive layer 444. According to the present embodiment, the thermoplastic resin softens and has moderate fluidity. Therefore, when appropriate pressure is applied to the thermoplastic resin, the thermoplastic resin moves toward the inside of the through-hole 620 formed in the electrically conductive layer 442 and the electrically conductive layer 444 of the welded region and/or the outside of the welded region.

The controller 1160 of the welding device 1120 may control the position adjustment unit 1132 to apply pressure to the stacked current collector 1102 and current collector 1104 such that the softened resin material flows into at least a part of the through-hole 620 arranged in the softened region and/or the welded region. In this way, the volume expansion of the surroundings of the welded region due to welding is significantly suppressed.

The controller 1160 may control the position adjustment unit 1132 to apply pressure to the stacked current collector 1102 and current collector 1104 such that the softened resin material fractures the electrically conductive layer 642 arranged on the surface of the inner wall portion 622 of at least a part of the through-holes 620 arranged in the softened region and/or the welded region and flows into the through-hole 620. In this way, the volume expansion of the surroundings of the welded region due to welding is significantly suppressed.

Then current and/or voltage is applied to the pressed welded region. In this way, each electrically conductive layer 442 and electrically conductive layer 444 of the current collector 1102 and the current collector 1104 are welded. In addition, for example, the electrically conductive layer 444 of the current collector 1102 and the electrically conductive layer 442 of the current collector 1104 are welded. As a result, a stack in which a part of each electrically conductive layer 442 and electrically conductive layer 444 of the current collector 1102 and the current collector 1104 are integrated is fabricated.

For example, the controller 1160 of the welding device 1120 controls the welding power supply 1150 to supply electrical power from the welding power supply 1150 to the welding unit 1136. In this way, current and/or voltage is applied to the pressed welded region and welding current flows into each electrically conductive layer 442 and electrically conductive layer 444 of the current collector 1102 and the current collector 1104. At this time, the controller 1160 of the welding device 1120 may control the position adjustment unit 1132 and the welding power supply 1150 to apply current and/or voltage to the welded region while further pressing the welded region.

According to the present embodiment, in each of the current collector 1102 and the current collector 1104, the electrically conductive layer 442 and the electrically conductive layer 444 are electrically connected by the electrically conductive layer 642. In this way, welding current flows into the electrically conductive layer 442 and the electrically conductive layer 444 of the current collector 1102 as well as the electrically conductive layer 442 and the electrically conductive layer 444 of the current collector 1104. As a result, four electrically conductive layers are integrated in at least a part of the welded region.

In this way, a stack in which the electrically conductive layer 442 and the electrically conductive layer 444 in the current collector 1102 are integrated with the electrically conductive layer 442 and the electrically conductive layer 444 of the current collector 1104 in the vicinity of one end of the current collector 1102 and the current collector 1104 is fabricated. There may be thermoplastic resin in the region where a part of the electrically conductive layer 442 and the electrically conductive layer 444 are integrated (sometimes referred to as an integrated region). There may be voids in the integrated region. In this way, a stack is fabricated in which at least one of the thermoplastic resin or voids are distributed inside the integrated metal.

In the integrated region, the electrically conductive layer 442 and the electrically conductive layer 444 may have shapes different from those before welding. Similarly, the thermoplastic resin included in the support layer 420 may have shapes different from those before welding. A part of the integrated region may include the electrically conductive layer 442, the electrically conductive layer 444, and/or the support layer 420 which maintains shapes approximately similar to those before welding.

If the lead 822 is constituted of metal, a stack may be fabricated in which the lead 822, the electrically conductive layer 442 and the electrically conductive layer 444 of the current collector 1102, and the electrically conductive layer 442 and the electrically conductive layer 444 of the current collector 1104 are integrated. In this case, the integrated region refers to the region in which a part of the lead 822, the electrically conductive layer 442, and the electrically conductive layer 444 are integrated. Similarly, if the lead 822 and the sub-lead 824 are constituted of metal, a stack may be fabricated in which the lead 822, the electrically conductive layer 442 and the electrically conductive layer 444 of the current collector 1102, the electrically conductive layer 442 and the electrically conductive layer 444 of the current collector 1104, and the sub-lead 824 are integrated. In this case, the integrated region refers to the region in which a part of the lead 822, the electrically conductive layer 442, the electrically conductive layer 444, and the sub-lead 824 are integrated.

As described above, the plurality of through-holes 620 are formed in the welded region of the current collector 1102. Similarly, the plurality of through-holes 620 are formed in the welded region of the current collector 1104. During welding, a part of the above-described plurality of through-holes 620 are filled with metal included in the electrically conductive layer 442, the electrically conductive layer 444, and/or the electrically conductive layer 642. In this way, a part of the plurality of through-holes 620 disappears, or the volumes of the voids of a part of the plurality of through-holes 620 decrease. Similarly, during welding, a part of the plurality of through-holes 620 is filled with the thermoplastic resin included in the support layer 420. In this way, a part of the plurality of through-holes 620 disappears, or the volumes of the voids of a part of the plurality of through-holes 620 decrease. As a result, depending on the condition and/or situation during welding, the thermoplastic resin and/or void may remain in the integrated region.

It is noted that the integrated region may not include the thermoplastic resin and the integrated region may not include the voids. For example, the stack that does not include the thermoplastic resin and/or the voids in the integrated region may be fabricated by adjusting the extent of the press during welding and/or the magnitude of the welding current.

### (Resin Content in the Integrated Region)

The ratio of the volume of the resin existing in the integrated region to the volume of the metal existing in the integrated region (sometimes referred to as the resin content in the integrated region) may be 0% or may be from 0.1 to 50%. The above-described resin content is preferably from 0.1 to 50%, more preferably from 1 to 30%, and even more preferably from 5 to 20%.

If the lead 822 and/or the sub-lead 824 are constituted of metal and a stack is fabricated in which the lead 822 and/or the sub-lead 824, the electrically conductive layer 442 and the electrically conductive layer 444 of the current collector 1102, and the electrically conductive layer 442 and the electrically conductive layer 444 of the current collector 1104 are integrated, the resin content in the integrated region may be derived as the ratio of the volume of the resin existing in the integrated region to the volume of the metal derived from the electrically conductive layer 442 and the electrically conductive layer 444 existing in the integrated region. The volume of the metal derived from the electrically conductive layer 442, the electrically conductive layer 444, and/or the electrically conductive layer 642 may be the volume of the same type of metal as the component mainly constituting the electrically conductive layer 442, the electrically conductive layer 444, and/or the electrically conductive layer 642 (sometimes referred to as a main component).

For example, if the main component of the lead 822 and/or the sub-lead 824 is different from the main component of the electrically conductive layer 442 and the electrically conductive layer 444 of the current collector 1102 as well as the main component of the electrically conductive layer 442 and the electrically conductive layer 444 of the current collector 1104, the boundary between the metal derived from the lead 822 and/or the sub-lead 824 and the metal derived from the electrically conductive layer 442 and/or the electrically conductive layer 444 is determined by, for example, observing, using the scanning electron microscope (SEM), the cross-section obtained by cutting the integrated region by a plane approximately parallel to the stack direction (the vertical direction in FIG. 11) of the plurality of integrated current collectors. The same applies to the case where the main component of the lead 822 and/or the sub-lead 824 is different from the main component of the electrically conductive layer 442, the electrically conductive layer 444, and the electrically conductive layer 642 of the current collector 1102 as well as the main component of the electrically conductive layer 442, the electrically conductive layer 444, and the electrically conductive layer 642 of the current collector 1104.

For example, if the main component of the lead 822 and/or the sub-lead 824 is the same as or similar to the main component of the electrically conductive layer 442 and/or the electrically conductive layer 444, it may be relatively difficult to determine the position of the above-described boundary based on the observation of the cross-section of the integrated region. In this case, the position of the above-described boundary may be estimated based on the position of the boundary between the lead 822 and/or the sub-lead 824 and the electrically conductive layer 442 and/or the electrically conductive layer 444 in the adjacent region where the metal derived from the lead 822 and/or the sub-lead 824 is not integrated with the metal derived from the electrically conductive layer 442 and/or the electrically conductive layer 444.

The above-described resin content may be from 5 to 50%. The above-described resin content is preferably from 5 to 30% and more preferably from 5 to 20%. According to the present embodiment, the through-holes 620 are formed in the softened region and/or the welded region. Therefore, the above-described resin content may be higher, compared to the case where the through-holes 620 are not formed in the softened region and/or the welded region. In addition, a relatively high resin content may imply that the through-holes 620 are formed in the softened region and/or the welded region.

If the resin content exceeds 50%, the welding is insufficient and the durability of the welding unit decreases. In addition, if the resin content exceeds 50%, the electrical conductivity between the lead 822 and the sub-lead 824 decreases, and the resistance increases. On the other hand, if an appropriate amount of resin is included in the integrated region, the resin may contribute to the ensured intensity of the integrated region. In addition, in this case, since a sufficient amount of electrically conductive material is included in the integrated region, the electrical conductivity of the integrated region is ensured.

The ratio of the volume of the thermoplastic resin derived from the support layer 420, among the resin existing in the integrated region, to the volume of the metal derived from the electrically conductive layer 442, the electrically conductive layer 444, and/or the electrically conductive layer 642, among the metal existing in the integrated region, may be from 5 to 50%. The above-described ratio may be from 10 to 50%, may be from 10 to 40%, or may be from 5 to 30%. As described above, for example, if the main component of the lead 822 and/or the sub-lead 824 is different from the main component of the electrically conductive layer 442 and the electrically conductive layer 444 of the current collector 1102 as well as the main component of the electrically conductive layer 442 and the electrically conductive layer 444 of the current collector 1104, the volume of the metal derived from the electrically conductive layer 442, the electrically conductive layer 444, and/or the electrically conductive layer 642, among the metal existing in the integrated region, may be relatively easily determined through observation using the scanning electron microscope.

As described above, the resin content in the integrated region is determined by, for example, observing, using the scanning electron microscope (SEM), the cross-section obtained by cutting the integrated region by the plane approximately parallel to the stack direction of the plurality of integrated current collectors (the vertical direction in FIG. 11). The above-described cross-section (that is, the plane observed with the SEM) may be the cross-section obtained by cutting the integrated region by a plane (the plane extending through the page in the approximately perpendicular direction in FIG. 11) that is approximately parallel to the stack direction of the plurality of integrated current collectors (the vertical direction in FIG. 11) and that is approximately perpendicular to the extending direction of the plurality of current collectors (the horizontal direction in FIG. 11).

The above-described cross-section may be a plane passing through the approximate center of the integrated region. The approximate center of the integrated region is determined by, for example, visually observing the surface on one side of the plurality of integrated current collectors (for example, the first planer surface 422). The above-described surface may be the surface on the side of the first planer surface 422 of the current collector arranged on the top surface or may be the surface on the side of the second planer surface 424 of the current collector arranged at the bottom surface.

In the step of cutting the integrated region of the stack to observe the cross-section of the stack using the SEM, the approximate position of the outer edge of the integrated region is determined by, for example, visually confirming the weld mark. It is noted that the exact position of the outer edge of the integrated region is determined by, for example, observing the cross-section using the SEM after the integrated region of the stack is cut.

According to one embodiment, appropriate adjustment of the magnification of the SEM image in the vicinity of the outer edge of the integrated region may allow visual distinction between the region in which the plurality of electrically conductive layers are integrated and the region in which the plurality of electrically conductive layers are only in contact but are not integrated. In this way, the position of the outer edge of the integrated region (sometimes referred to as the end) may be determined.

According to another embodiment, the position of the outer edge of the integrated region is determined based on the length of the stack in the stack direction of the plurality of current collectors (sometimes referred to as the thickness). For example, the position at which the thickness in the vicinity of the end of the integrated region is 1.1 times the average value of the thickness in the vicinity of the center of the integrated region (for example, Hu described below) is determined as the end of the integrated region. The thickness of the vicinity of the center of the integrated region is determined by, for example, averaging the thickness at the positions of three points in the SEM image of the vicinity of the center of the integrated region. If the plurality of current collectors are welded using the lead and the sub-lead, the thickness of the integrated region may be the distance of the lead and the sub-lead.

The resin content in the integrated region is derived as, for example, the ratio of the area of the thermoplastic resin in the SEM image to the area of metal in the SEM image. The resin content in the integrated region may be derived as the average value of the resin content obtained by observing each of the plurality of SEM images with different observation positions in a single cross-section. For example, at first, five resin contents corresponding to each of the five SEM images are derived. Then, three measurement values excluding the highest and lowest measurement values among the five measurement values of the resin contents are averaged. In this way, the resin content in the integrated region is determined. One of the plurality of SEM images may be an image of the approximate center of the integrated region.

### (The Void Ratio in the Integrated Region)

The ratio of the volume of voids to the volume of the metal in the integrated region (sometimes referred to as the void ratio in the integrated region) may be from 0 to 10%. The void ratio in the integrated region is preferably from 0 to 10%, more preferably from 0.1 to 8%, and more preferably from 0.1 to 5%. The void ratio in the integrated region may exceed 10%. However, as the void ratio increases, the intensity and electrical conductivity of the integrated region decrease. Therefore, the void ratio in the integrated region is preferably 10% or less.

According to the present embodiment, the through-holes 620 are formed in the softened region and/or the welded region. Therefore, the above-described void ratio may be higher, compared to the case where the through-holes 620 are not formed in the softened region and/or the welded region. In addition, a relatively high void ratio may imply that the through-holes 620 are formed in the softened region and/or the welded region.

The void ratio in the integrated region is determined by, for example, observing, by using the scanning electron microscope (SEM), the cross-section obtained by cutting the integrated region by the plane approximately parallel to the stack direction of the plurality of integrated current collectors (the vertical direction in FIG. 11). The void ratio in the integrated region is determined through, for example, a procedure similar to that for the resin content in the integrated region.

As described above, the above-described stack constitutes a part of the stack structure 760. As described with reference to FIG. 8, the stack structure 760 includes a structure in which a first positive electrode 220, a first separator 230, a first negative electrode 240, a second separator 230, a second positive electrode 220, a third separator 230, and a second negative electrode 240 are stacked in this sequence.

In the present embodiment, the positive electrode connection 820 including the stack of the current collector 1102 and the current collector 1104 is arranged in the vicinity of the ends of the positive electrode 220 including the current collector 1102 and the positive electrode 220 including the current collector 1104. Therefore, according to the present embodiment, two positive electrodes 220 are integrated in the vicinity of these ends. In this way, the mass of the power storage cell 112 decreases compared to the case where a tab is provided on each of the plurality of current collectors and the tabs of the plurality of current collectors are electrically connected via wiring. As a result, the power storage cell 112 with a high mass energy density is obtained.

In the present embodiment, before the above-described softening process or pressing process for the thermoplastic resin is performed, the current collector 1102 and the current collector 1104 are reinforced using the lead 822 and the sub-lead 824. In this way, the fracture of the electrically conductive layer 442 and/or the electrically conductive layer 444 due to the pressure applied during welding is prevented.

The current collector 1102 may be one example of the welding target, the sheet material, the first sheet material, or the third sheet material. The current collector 1104 may be one example of the welding target, the sheet material, the second sheet material, or the third sheet material. The electrically conductive layers 442 of the current collector 1102 and the current collector 1104 may be one example of the first metal layer. The electrically conductive layers 444 of the current collector 1102 and the current collector 1104 may be one example of the second metal layer. The electrically conductive layer 642 of the current collector 1102 and the current collector 1104 may be one example of the electrically conductive member arranged on the inner wall of the through-hole.

One example of the plurality of through-holes 620 arranged on the current collector 1102 is described with reference to FIG. 12 and FIG. 13. FIG. 12 is one example of the top view of the current collector 1102. FIG. 13 is one example of the cross-sectional view of the current collector 1102. It is noted that the plurality of through-holes 620 arranged on the current collector 1104 may have characteristics similar to those of the plurality of through-holes 620 arranged on the current collector 1102.

As illustrated in FIG. 12, in the present embodiment, the diameter d of each of the plurality of through-holes 620 (for example, the circular equivalent diameter) may be from 15 μm to 150 μm. If the diameter d is less than 15 μm, the thermoplastic resin is less likely to flow into the through-hole 620. In addition, since the volume of the through-hole 620 is small, the volume expansion rate of the welded stack is high. On the other hand, if the diameter d exceeds 150 μm, the intensity of the current collector 1102 is low and the current collector 1102 is likely to fracture during welding.

In the present embodiment, the interval of the two adjacent through-holes 620 (sometimes referred to as a pitch) P may be from 30 μm to 250 μm. If the pitch P is less than 30 μm, the intensity of the current collector 1102 is low and the current collector 1102 is likely to fracture during welding. In addition, the resistance of the current collector 1102 is high. On the other hand, if the pitch P exceeds 250 μm, the moving amount of the thermoplastic resin is high and the volume expansion rate of the welded stack is high.

The length TL of the current collector 1102 in the extending direction may be greater than the length HL of the region where the plurality of through-holes 620 are formed (sometimes referred to as a through-hole zone), or TL and HL may be approximately the same. The length TW in the direction (sometimes referred to as the width direction) approximately perpendicular to the extending direction of the current collector 1102 may be greater than the length HW in the width direction of the through-hole zone, or TW and HW may be approximately the same.

In the present embodiment, the above-described welded region is arranged inside the through-hole zone. At least a part of the above-described softened region is arranged inside the through-hole zone. For example, the above-described adjacent region is arranged inside the through-hole zone. The above-described softened region may be arranged inside the through-hole zone.

The size of the softened region Rs may be determined based on the size of the welded region Rw. The size of the softened region Rs is determined such that, for example, the ratio of the area Ss of the softened region Rs in the first planer surface 422 or the second planer surface 424 of the support layer 420 to the area Sw of the welded region Rw in the first planer surface 422 or the second planer surface 424 of the support layer 420 is indicated by the Expression 1 described below. In this way, the volume of the through-hole 620 existing inside the softened region Rs is equal to or more than the volume of the thermoplastic resin existing inside the welded region Rw.

Ss/Sw≥(1−εw+εout)/εout (Expression 1)

In Expression 1, εw represents the void ratio of the plurality of through-holes in the welded region Rw. εout represents the void ratio of the plurality of through-holes in the region other than the welded region Rw of the softened region Rs. εw and εout are the void ratios at the temperature for the softening process.

The void ratio εw of the plurality of through-holes in the welded region Rw may be 10% or more at the temperature for the softening process. The void ratio εw at the temperature for the softening process is preferably 20% or more, and more preferably 30% or more.

As illustrated in FIG. 13, the electrically conductive layer 642 is formed inside the through-hole 620. Therefore, the diameter dv of the space formed inside the through-hole 620 is smaller than the diameter d of the through-hole 620.

As described above, the thickness Hd of the electrically conductive layer 642 may be from 0 μm to 5 μm. The thickness Hd of the above-described electrically conductive layer 642 is preferably from 0.1 μm to 3 μm and more preferably from 0.1 μm to 1 μm.

As described above, the thickness hr of the support layer 420 may be from 0.5 μm to 20 μm. The thickness hr of the above-described support layer 420 is preferably from 1 μm to 10 μm and more preferably from 2 μm to 8 μm.

As described above, the thickness hm of the electrically conductive layer 442 and the electrically conductive layer 444 may be from 0.1 μm to 10 μm. The thickness hm of the above-described electrically conductive layer 442 and electrically conductive layer 444 is preferably from 0.1 μm to 5 μm and more preferably from 0.1 μm to 1 μm.

FIG. 14 illustrates one example of a procedure for fabricating the stack structure 760 in which parts of the positive electrode current collector 222 of each of the plurality of positive electrodes 220 are integrated. As described with reference to FIG. 11, according to the present embodiment, at first, at S1410, the plurality of positive electrodes 220 are prepared. Then, at S1420, the ends of the positive electrode current collectors 222 of the plurality of positive electrodes 220 are stacked. At S1430, the lead 822 and the sub-lead 824 are installed such that the lead 822 and the sub-lead 824 sandwich the ends of the stacked positive electrode current collectors 222.

At S1440, energy is applied to the softened region of the stacked positive electrode current collectors 222 to soften the thermoplastic resin included in the support layer 420 of the positive electrode current collector 222. At S1450, the welded regions of the stacked positive electrode current collectors 222 are pressed to move the softened thermoplastic resin into the through-hole 620 of the positive electrode current collectors 222. At S1450, welding current is applied to the welded regions of the stacked positive electrode current collectors 222 to weld the electrically conductive layer 442 and the electrically conductive layer 444 of the positive electrode current collector 222.

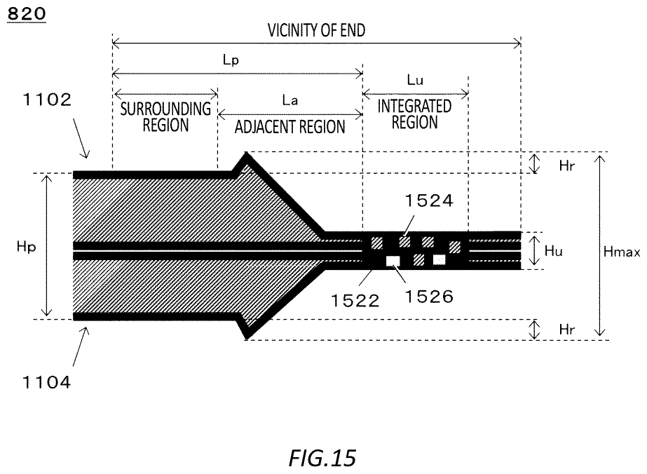

FIG. 15 schematically illustrates one example of the cross-section of the ends of the current collector 1102 and the current collector 1104 in the positive electrode connection 820 described with reference to FIG. 11 and the vicinity of the ends. The negative electrode connection 840 may also have a constitution similar to that of the positive electrode connection 820. As illustrated in FIG. 15, the integrated region, the adjacent region adjacent to the integrated region, and the surrounding region adjacent to the adjacent region are arranged in the vicinity of the ends of the current collector 1102 and the current collector 1104.

In FIG. 15, for the purpose of simplifying the description, the current collector 1102 and the current collector 1104 are depicted as if a gap exists between them. However, it is noted that in reality the current collector 1102 and the current collector 1104 are in contact with each other. In addition, in FIG. 15, for the purpose of simplifying the description, the through-holes formed in the current collector 1102 and the current collector 1104 are not depicted. Furthermore, for the purpose of simplifying the description, in an embodiment described with reference to FIG. 15, the detail of the positive electrode connection 820 is described by using an example in which two current collectors are stacked. However, it is noted that the number of the stacked current collectors is not limited to two.

According to the embodiment described with reference to FIG. 11, the welding process is performed while the ends of the current collector 1102 and the current collector 1104 and a part of the vicinity of the end are sandwiched by the lead 822 and the sub-lead 824. Therefore, the thermoplastic resin extruded from the welded region including the integrated region flows to the adjacent region. As a result, a part of the adjacent region has a swelled shape. In the surrounding region, the current collector 1102 and the current collector 1104 have a shape similar to that before welding. According to the present embodiment, the average value Hp of the thickness of the surrounding region is higher than the average value Hu of the thickness of the integrated region and is lower than the maximum value Hmax of the thickness of the adjacent region. As described above, the average value Hu of the thickness of the integrated region may be the average value of the thickness of the integrated region in the vicinity of the center of the integrated region.

The average value of the thickness of the integrated region is determined by averaging the measurement values at three points. The average value of the thickness of the surrounding region is determined by averaging the measurement values at the three points. The thickness at five points in each region is measured and the average value of the measurement values at the three points excluding the maximum value and the minimum value may be derived as the average value of the thickness of each region. The measurement interval is set as appropriate so that the above-described number of measurement values are obtained.

In the present embodiment, the integrated region has the length of Lu. In the integrated region, for example, there are a metal material 1522 and at least one of the thermoplastic resin material 1524 or the void 1526. The thermoplastic resin material 1524 is arranged inside the metal material 1522. The void 1526 is arranged inside the metal material 1522. One or more resin materials 1524 or one or more voids 1526 may be arranged inside the metal material 1522. A plurality of resin materials 1524 or a plurality of voids 1526 may be arranged to be distributed inside the metal material 1522.

As described above, in the present embodiment, the plurality of through-holes 620 extending through the current collector 1102 or the current collector 1104 are formed in the welded regions of the current collector 1102 and the current collector 1104. The thermoplastic resin material 1524 is derived from, for example, the thermoplastic resin included in the support layer 420. The void 1526 is derived from, for example, the through-hole 620 formed in the electrically conductive layer 442 and/or the electrically conductive layer 444.

The metal material 1522 includes, for example, the same type of electrically conductive material as the electrically conductive material included in the electrically conductive layer 442 and/or the electrically conductive layer 444 (for example, metal). It may include the same type of electrically conductive material (for example, metal) as the main component of the electrically conductive layer 442 and/or the electrically conductive layer 444. The metal material 1522 may include the same type of electrically conductive material (for example, metal) as the electrically conductive material included in the electrically conductive layer 642. The metal material 1522 may include the same type of electrically conductive material (for example, metal) as the main component of the electrically conductive layer 642. The metal material 1522 may include the same type of electrically conductive material (for example, metal) as the electrically conductive material included in the lead 822. The metal material 1522 may include the same type of electrically conductive material (for example, metal) as the main component of the lead 822.

In the present embodiment, the adjacent region is, for example, a region where the distance from the end of the integrated region is 0 or more and less than La. As described above, the welded region is arranged inside the through-hole zone of the current collector and a part of the thermoplastic resin extruded from the welded region in the welding process flows into the through-hole arranged in the adjacent region. Therefore, the through-holes, the through-holes partially filled with thermoplastic resin, and/or the through-holes completely filled with the thermoplastic resin may exist in the adjacent region.

In the present embodiment, the surrounding region is, for example, a region where the distance from the end of the integrated region is La or more and Lp or less. The end of the integrated region is, for example, at a position where the thickness is 1.1 times the average value Hu of the thickness of the integrated region when the cross-section of the positive electrode connection 820 including the integrated region is observed using the SEM. If there are a plurality of positions where the thickness is 1.1 times the average value Hu of the thickness of the integrated region, the end of the integrated region may be the position closest to the center of the integrated region among the plurality of positions.

As described above, the surrounding region is a region where the shape hardly changes before and after the welding process. In the present embodiment, a part of the thermoplastic resin existing in the integrated region before welding moves to the adjacent region during welding. Therefore, (a) the resin content in the integrated region after welding is lower than (b) the resin content in the surrounding region of the current collector 1102 or the current collector 1104 after welding. (a) the resin content in the integrated region after welding may be from 0.1 to 0.7 times (b) the resin content in the surrounding region after welding.

The resin content at the position 5 mm or more away from the end of the integrated region is preferably employed as the resin content in the surrounding region. In addition, if the resin contents in the surrounding regions are different among the plurality of current collector stacked in the positive electrode connection 820, (a) the resin content in the integrated region after welding and (b) the resin content of the current collector with the highest resin content in the surrounding region among the plurality of stacked current collectors may be compared.

La may be 1 mm, may be 5 mm, or may be 10 mm. Lp is a value greater than La, may be 1 mm, may be 5 mm, or may be 10 mm.

In the present embodiment, the maximum value Hmax of the thickness of the adjacent region is, for example, 1.5 times or less the average value Hp of the thickness of the surrounding region. The maximum value Hmax of the thickness of the adjacent region is preferably 1.3 times or less the average value Hp of the thickness of the surrounding region and more preferably 1.1 times or less the average value Hp of the thickness of the surrounding region.

In another embodiment, the thickness at the position at a distance 100 μm from the end of the integrated region may be 1.5 times or less the thickness at the position at a distance of 1 mm from the end of the integrated region. The thickness at the position at a distance of 100 μm from the end of the integrated region may be 1.3 times or less the thickness at the position at a distance of 1 mm from the end of the integrated region or may be 1.1 times or less the thickness at the position at a distance of 1 mm from the end of the integrated region.

According to the present embodiment, a part of the thermoplastic resin existing in the integrated region before welding moves to the adjacent region during welding. Therefore, before and after the welding process, a part of the adjacent region swells compared to the surrounding region. The height Hr of the swelled portion on the side of one face may be 25% or less, may be 15% or less, or may be 5% or less of Hp. The ratio of Hr to Hp may be from 0.1 to 20%, preferably from 1 to 15%, and more preferably from 2 to 10%.

If the ratio of Hr to Hp is less than 0.1%, it is likely that the thermoplastic resin of the support layer 420 is insufficiently softened and welding is also insufficient. On the other hand, if the ratio of Hr to Hp exceeds 25%, it is likely that local expansion of the current collector causes weld peeling, fracture of the foil, partial crack of the electrically conductive layer, or the like. In addition, as a result, the performance of the battery may decrease.

According to the present embodiment, the through-holes 620 are formed in the softened region and/or the welded region. Therefore, the ratio of Hr to Hp is lower, compared to the case where the through-holes 620 are not formed in the softened region and/or the welded region. In this way, the weld peeling, the fracture of the foil, the partial crack of the electrically conductive layer, or the like may be prevented. In addition, as a result, the performance of the battery may improve. It is noted that a relatively low ratio of Hr to Hp may imply that the through-holes 620 are formed in the softened region and/or the welded region. Similarly, (a) the resin content in the integrated region after welding lower than (b) the resin content in the surrounding region after welding may imply that the through-holes 620 are formed in the softened region and/or the welded region.

The current collector 1102 may be one example of the current collector included in the first electrode or the second electrode. The current collector 1104 may be one example of the current collector included in the first electrode or the second electrode. The plurality of stacked current collectors may be one example of the plurality of sheet materials. The current collector with the highest resin content in the surrounding region among the plurality of stacked current collectors may be one example of the third sheet material. The resin content in the integrated region after welding may be one example of the first ratio. The resin content in the surrounding region after welding may be one example of the second ratio.

### EXAMPLE

Hereinafter, an example is shown, and the present invention is specifically described. The present invention is not restricted by the following example.

### Example 1

The current collector to be the welding target was fabricated through the procedure described below. In addition, a part of five current collectors were welded to fabricate the stack.

### (Fabrication of the Current Collector)

At first, polyimide film (Toray-DuPont, Kapton, thickness: 5 μm) was prepared as the support layer of the current collector. Then, a nickel layer and a copper layer were formed on both faces of the polyimide film by electroless plating. The nickel layer was formed between the polyimide film and the copper layer. The thickness of the nickel layer was 0.1 μm. The thickness of the copper layer was 1 μm.

Then, the through-hole zone, in which the plurality of through-holes are formed, was formed on a part of the polyimide film. The shape of the cross-section of each through-hole was circular and the average diameter of each through-hole was 50 μm. In addition, the pitch of the through-holes was 100 μm.

Then, the copper layer was formed on the inner wall of the through-hole by electroless plating. The thickness of the copper layer was 1 μm. The average diameter of the space of the through-hole after the formation of the copper layer was 48 μm.

The five current collectors were fabricated by cutting the polyimide film on which the through-hole zone and the copper layer within the through-hole are formed. The above-described polyimide film was cut such that each current collector had an L-shaped planar shape having a 37 mm×32 mm rectangular current collecting unit and a 10 mm×10 mm square tab part. In each current collector, the above-described polyimide film was cut such that one edge of the tab part was in contact with one of the longer edges of the current collecting unit. In each current collector, the above-described polyimide film was cut such that the other one edge of the tab part and one of the shorter edges of the current collecting unit were arranged on the same straight line. The above-described other one edge of the tab part was the edge in contact with the edge in contact with one of the longer edges of the current collecting unit.

As described above, the TL of the tab part of each current collector was 10 mm and the TW was 10 mm. The through-hole zone was formed on the tab part of each current collector and the HL of each current collector was 7 mm and the HW was 10 mm. The distance from the edge in contact with the current collecting unit among the edges of the tab part to the through-hole zone was 1 mm. The distance from the edge on the side opposite to the edge in contact with the current collecting unit among the edges of the tab part to the through-hole zone was 2 mm.

### (Fabrication of the Stack)

The five current collectors were stacked such that the positions of the through-hole zones of the five current collectors approximately match. The 3.0 mm×5.0 mm region inside the through-hole zone of the current collector was set as the welded region. The stacked five current collectors were placed in the work region of the welding device 1120 while the stacked five current collectors were sandwiched between a Cu lead with Ni plating and a Cu sub-lead with Ni plating. The thickness of the sub-lead was 70 μm and the area of the sub-lead was 10 mm×30 mm.

A lithium-ion battery stacked foil welding device from Nag Systems Co., Ltd. was used as the welding device 1120. After the welding head 1130 of the welding device 1120 was in contact with the welded region, electrical power was supplied to the heating unit 1134 and the welded region was heated. Subsequently, electrical power was supplied to the welding unit 1136 to weld the welded region. The condition for supplying electrical power during heating and welding was a current of 1.0 to 2.5 kA, a voltage of 1.5 to 2.5 V, and an application time of 10 to 70 ms.

### Example 2

The stack was fabricated in a procedure similar to that of Example 1 by varying the number of stacks of the current collector, the thickness of the sub-lead, the diameter of the through-hole, the pitch of the through-hole, the thickness per one face of the electrically conductive layer formed on both faces of the support layer, and the thickness of the copper layer formed on the inner surface of the through-hole. The detail of the fabrication condition for the stack is indicated in Table 1.

### Comparative Example 1

The five current collectors were prepared through a procedure similar to that of Example 1. The five current collectors were welded through a procedure similar to that of Example 1 except that a high power ultrasonic metal joining machine from Seidensha Electronics Co., Ltd. was used and the heating process before welding process was omitted. The condition for the ultrasonic welding using the high power ultrasonic metal joining machine was: a power supply of 600 kW, a joint frequency of 19.15 kHz, a pressure value of 623 N, a joint indentation of 0.1 mm, a joint time of 0.5 to 1 s, an amplitude of 80%, a soft start of 100 ms, a power of 100 W, a speed of 300 mm/s, no cooling, and a frequency offset of 20 Hz. In addition, the current value was approximately from 5 to 19 A.

### Comparative Example 2

The stack was fabricated through a procedure similar to that of Example 1 except that the through-holes are not formed on the polyimide film. The detail of the fabrication condition for the stack is indicated in Table 1.

### Comparative Example 3

The stack was fabricated through a procedure similar to that of Example 1 except that the sub-lead was not used. The detail of the fabrication condition for the stack is indicated in Table 1.

### Comparative Example 4

The stack was fabricated through a procedure similar to that of Example 1 by varying the thickness of the sub-lead, the diameter of the through-hole, and the pitch of the through-hole. The detail of the fabrication condition for the stack is indicated in Table 1.

### Comparative Example 5

The stack was fabricated through a procedure similar to that of Example 1 by varying the thickness of the sub-lead, the diameter of the through-hole, and the pitch of the through-hole. The detail of the fabrication condition for the stack is indicated in Table 1.

TABLE 1

| | | | | | | THICKNESS OF | | |
|---|---|---|---|---|---|---|---|---|
| | | SUB-LEAD | | THOUGH- | PITCH | ELECTRICALLY | THICKNESS OF | |
| | NUMBER | PLANAR | | HOLE | INTERVAL | CONDUCTIVE | PLATING | |
| | OF | SHAPE | THICKNESS | SIZE d | P | LAYER | LAYER Hd | WELDING |
| No | STACKS | _mm_{—} | [μm] | [μm] | [μm] | [μm] | [μm] | METHOD |
| EXAMPLE 1 | 5 | 10 × 30 | 70 | 50 | 100 | 1 | 1 | RESISTANCE |
| EXAMPLE 2 | 15 | 10 × 30 | 100 | 100 | 200 | 0.5 | 0.5 | RESISTANCE |
| COMPARATIVE | 5 | 10 × 30 | 70 | 50 | 100 | 1 | 1 | ULTRASONIC |
| EXAMPLE 1 | | | | | | | | |
| COMPARATIVE | 5 | 10 × 30 | 100 | — | — | 1 | — | RESISTANCE |
| EXAMPLE 2 | | | | | | | | |
| COMPARATIVE | 5 | — | — | 50 | 100 | 1 | 1 | RESISTANCE |
| EXAMPLE 3 | | | | | | | | |
| COMPARATIVE | 5 | 10 × 30 | 10 | 200 | 280 | 1 | 1 | RESISTANCE |
| EXAMPLE 4 | | | | | | | | |
| COMPARATIVE | 5 | 10 × 30 | 10 | 10 | 50 | 1 | 1 | RESISTANCE |
| EXAMPLE 5 | | | | | | | | |

### (Evaluation)

For each of Example 1 and Example 2 and Comparative example 1 to Comparative example 5, a tensile test of the current collector, a welding confirmation test of the stack, and a resistance measurement test of the stack were performed. Table 2 indicates the result of each test.

The tensile test of the current collector was performed through a procedure similar to that of the tensile test for the sample described in relation to the degree of resistance to the fracture of the current collector 400. Those with the tensile strength of 450 MPa or more are indicated by a double circle, those with the tensile strength of 360 MPa or more are indicated by a single circle, and the others are indicated by a multiplication sign.

The welding confirmation test for the stack was performed by peeling off the lead from the stack after welding and then measuring, by using a spring scale, the force needed to peel off the current collectors one by one from the stack after welding. Specifically, whether the welding was performed with sufficient durability was confirmed through the procedure described below.

At first, the lead arranged on one face of the stack after welding was peeled off. Then, the other face of the stack was adhered to a flat face arranged approximately horizontally using adhesive. In this way, the stack after welding was firmly fixed to the flat face. Then, a spring scale was attached to the tip of one end of the current collector arranged on the top among the m current collectors constituting the stack after welding (m is an integer of 2 or more). The current collector arranged on the top was peeled off from the rest of the current collectors by pulling the spring scale such that the pulling direction is the approximately vertical direction. The current collectors were peeled off one by one by repeating the above-described procedure. If the difference between the measurement value of the first current collector and the measurement value of the nth current collector (n is an integer of 2 or more and m or less) is 50% or more, the result was considered as a fail. If the above-described difference was less than 50%, the result was considered as a pass. In Table 2, the pass is indicated with a single circle and the fail is indicated with a multiplication sign.

The measurement test for the resistance value was performed by measuring the resistance value for each of the plurality of current collectors included in the stack while the lead was attached to the stack. At first, the sample of the stack after welding was cut into pieces with a size of 10 mm×40 mm such that the entire tab part of each current collector is included. As indicated in Table 1, in each Example and each Comparative example, the stack includes five or fifteen current collectors. Then, the resistance value was measured for each current collector according to the procedure described below. The resistance value of each current collector included in the sample was measured using the resistance measurement machine. One of the pair of measurement electrodes was in contact with the lead and one of the pair of measurement electrodes was in contact with the electrically conductive layer (the metal foil) of the current collector to be the measurement target. Voltage was applied to the measurement electrode and the resistance value of each current collector was measured.

Then, a statistical process was performed for the resistance value of each of the plurality of current collectors constituting the stack. Specifically, at first, the median value of the resistance value of each of the plurality of current collectors was calculated. Then, the resistance values of the current collectors other than the current collector indicating the above-described median value (sometimes referred to as the other current collectors) was compared to the median value. If the above-described other current collectors include a current collector in which the difference between the resistance value of the current collector and the above-described median value was greater than 50% of the median value, the result of the measurement test of the stack was considered as a fail. If the above-described other current collectors do not include a current collector in which the difference between the resistance value of the current collector and the above-described median value was greater than 50% of the median value, the result of the measurement test of the stack was considered as a pass. In Table 2, the pass is indicated with a single circle and the fail is indicated with a multiplication sign.

TABLE 2

| | | WELDING | |
|---|---|---|---|
| | TENSILE | CONFIRMATION | VARIATION IN |
| No | TEST | TEST | RESISTANCE |
| EXAMPLE 1 | ⊚ | ◯ | ◯ |
| EXAMPLE 2 | ◯ | ◯ | ◯ |
| COMPARATIVE | ⊚ | X | X |
| EXAMPLE 1 | | | |
| COMPARATIVE | ⊚ | ◯ | X |
| EXAMPLE 2 | | | |
| COMPARATIVE | ⊚ | X | X |
| EXAMPLE 3 | | | |
| COMPARATIVE | X | X | ◯ |
| EXAMPLE 4 | | | |
| COMPARATIVE | ⊚ | ◯ | X |
| EXAMPLE 5 | | | |

### (Cross-Section of the Integrated Region)

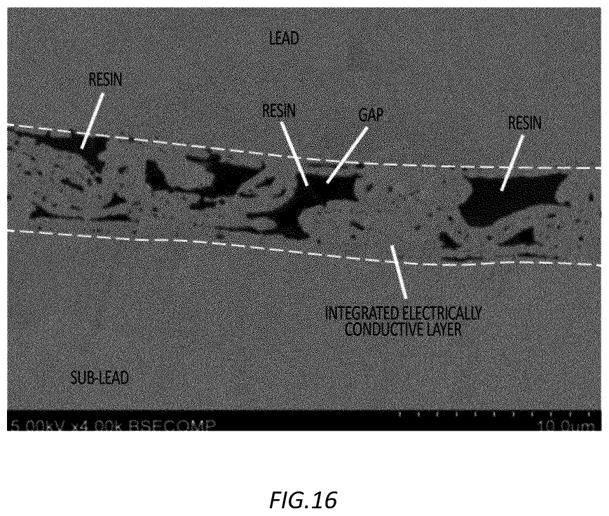

FIG. 16 illustrates the SEM image of the integrated region of the stack in Example 1. FIG. 16 illustrates the SEM image of the stack in the vicinity of the center of the welded region. As illustrated in FIG. 16, the resin and voids exist in the integrated region of the stack. In the stack in Example 1, the resin content in the integrated region was about 10%. In the stack in Example 1, the void ratio in the integrated region was about from 3 to 5%.

While the present invention has been described by way of the embodiments, the technical scope of the present invention is not limited to the above-described embodiments. It is apparent to persons skilled in the art that various alterations or improvements can be made to the above-described embodiments. It is also apparent from the described scope of the claims that the embodiments added with such alterations or improvements can be included the technical scope of the present invention.

It should be noted that the operations, procedures, steps, stages or the like of each process performed by an apparatus, system, program, and method shown in the scope of the claims, embodiments, or diagrams can be performed in any order as long as the order is not indicated by “prior to,” “before,” or the like and as long as the output from a previous process is not used in a later process. Even if the process flow is described by using phrases such as “first”, “then” or the like in the scope of the claims, embodiments, or diagrams, it does not necessarily mean that the process must be performed in this order.

For example, the following matters are disclosed in the present specification.

(item 1)

A method for producing an electrode, comprising:
preparing a current collector;
forming an active material layer that includes an organic compound as an active material on at least one face of the above-described current collector; and
securing the above-described active material layer and the above-described current collector;
wherein the above-described current collector includes:
an electrically conductive layer that includes an electrically conductive material; and
a support layer that supports the above-described electrically conductive layer;
wherein an electrical conductivity of the above-described support layer is lower than an electrical conductivity of the above-described electrically conductive layer;
a density of the above-described support layer is lower than a density of the above-described electrically conductive layer;
securing the above-described active material layer and the above-described current collector includes:
applying pressure to the above-described active material layer and the above-described current collector that are stacked,
the above-described pressure is set or adjusted such that:
(i) a change ratio of an electrical resistance of the above-described current collector before and after pressure is applied to the above-described active material layer and the above-described current collector is within 50%, or
(ii) an absolute value of a difference in an electrical resistance of the above-described current collector before and after pressure is applied to the above-described active material layer and the above-described current collector is less than 1 [Ω].
   (item 2)

A method for producing an electrode, comprising:
preparing a current collector;
forming an active material layer that includes an organic compound as an active material on at least one face of the above-described current collector;
securing the above-described active material layer and the above-described current collector;
the above-described current collector includes:
an electrically conductive layer that includes an electrically conductive material; and
a support layer that supports the above-described electrically conductive layer;
wherein an electrical conductivity of the above-described support layer is lower than an electrical conductivity of the above-described electrically conductive layer;
a density of the above-described support layer is lower than a density of the above-described electrically conductive layer;
securing the above-described active material layer and the above-described current collector includes:
applying pressure to the above-described active material layer and the above-described current collector that are stacked,
the above-described pressure is set or adjusted such that the value obtained by subtracting, from (i) the value of the second voltage measured by applying current to the above-described electrically conductive layer of the above-described current collector after the pressure is applied, (ii) the value of the first voltage measured by applying current to the above-described electrically conductive layer of the above-described current collector before the pressure is applied is less than 100 mV.
   (item 3)

A method for producing an electrode, comprising:
preparing a current collector;
forming an active material layer that includes an organic compound as an active material on at least one face of the above-described current collector; and
securing the above-described active material layer and the above-described current collector;
wherein the above-described current collector includes:
an electrically conductive layer that includes an electrically conductive material; and
a support layer that supports the above-described electrically conductive layer;
wherein an electrical conductivity of the above-described support layer is lower than an electrical conductivity of the above-described electrically conductive layer;
a density of the above-described support layer is lower than a density of the above-described electrically conductive layer;
securing the above-described active material layer and the above-described current collector includes:
applying pressure to the above-described active material layer and the above-described current collector that are stacked,
wherein the above-described pressure is set or adjusted such that
a porosity of the above-described active material layer after pressure is applied is from 25 to 40%.
   (item 4)

The method according to any one of item 1 to item 3,
wherein the applying the above-described pressure includes:
applying pressure to the above-described active material layer and the above-described current collector that are stacked using a roll press such that the linear load is from 1.0 kgf/cm to 200 kgf/cm.
   (item 5)

The method according to any one of item 1 to item 3, wherein
the above-described support layer is a sheet-shaped resin material.
   (item 6)

The method according to any one of item 1 to item 3,
wherein the above-described electrically conductive layer includes layer-shaped or foil-shaped aluminum,
the thickness of the above-described layer-shaped or foil-shaped aluminum is from 0.05 μm to 5 μm.
   (item 7)

A method for producing an electrode structure comprising;
preparing a positive electrode and a negative electrode;
preparing a separator; and
stacking the above-described positive electrode, the above-described separator, and the above-described negative electrode in this sequence;
wherein preparing the above-described positive electrode and negative electrode includes:
fabricating at least one of the above-described positive electrode or the above-described negative electrode through the method according to any one of item 1 to item 3.
   (item 8)

An electrode comprising:
a current collector; and
an active material layer that is arranged on at least one face of the above-described current collector and includes an organic compound as an active material;
wherein the above-described current collector includes:
an electrically conductive layer that includes an electrically conductive material; and
a support layer that supports the above-described electrically conductive layer,
wherein a thickness of the above-described electrically conductive layer is from 0.05 μm to 5 μm,
an electrical conductivity of the above-described support layer is lower than an electrical conductivity of the above-described electrically conductive layer,
a density of the above-described support layer is lower than a density of the above-described electrically conductive layer; and
an electrical resistance of the above-described current collector is from 0.01 mΩ to 1Ω.
   (item 9)

The electrode according to item 8,
wherein a porosity of the above-described active material layer is from 25 to 40%.
   (item 10)

The electrode according to item 8 or item 9,
wherein the above-described electrically conductive layer is an aluminum foil, and
the above-described support layer is a sheet-shaped resin material.
   (item 11)

The electrode according to item 8 or item 9,
wherein a plurality of through-holes are formed in the above-described current collector, and
a circular equivalent bore of each of the above-described plurality of through-holes is from 15 μm to 150 μm.
   (item 12)

The electrode according to item 11,
wherein a ratio of a total area of the above-described plurality of through-holes in one face of the above-described current collector to an area of a profile of the above-described one face of the above-described current collector is 30% or more.
   (item 13)

The electrode according to item 11, further comprising:
an internal electrically conductive layer that is arranged on an inner wall of at least a part of the above-described plurality of through-holes and includes an electrically conductive material.
   (item 14)

The stack according to item 13,
wherein the above-described internal electrically conductive layer has three or more layers with different main components.
   (item 15)

An electrode structure, comprising;
one or more positive electrodes;
one or more negative electrodes; and
one or more separators arranged between each of the above-described one or more positive electrodes and each of the above-described one or more negative electrodes,
wherein at least one of the above-described one or more positive electrodes or the above-described one or more negative electrodes is the electrode according to any one of item 8 or item 9.
   (item 16)

The electrode structure according to item 15,
wherein the above-described separator includes polymer solid electrolyte.
   (item 17)

A battery comprising:
the electrode structure according to item 15; and
a housing accommodating the above-described electrode structure.
   (item 18)

The battery according to item 17, further comprising:
at least one of a positive electrode connection electrically connecting the above-described one or more positive electrodes or a negative electrode connection electrically connecting the above-described one or more negative electrodes,
wherein the above-described positive electrode connection has a positive electrode supporting unit that sandwiches and supports a part of the above-described one or more positive electrodes, and
the above-described negative electrode connection has a negative electrode supporting unit that sandwiches and supports a part of the above-described one or more negative electrodes.
   (item 19)

A flight vehicle comprising:
the battery according to item 17; and
a propulsive force generator that generates propulsive force by using electrical energy accumulated in the above-described battery.

### EXPLANATION OF REFERENCES

100 flight vehicle;
110 power storage battery;
112 power storage cell;
120 power control circuit;
130 electric motor;
140 propeller;
150 sensor;
160 controller;
212 positive electrode case;
214 negative electrode case;
216 sealant;
218 metal spring;
220 positive electrode;
222 positive electrode current collector;
224 positive electrode active material layer;
230 separator;
240 negative electrode;
242 negative electrode current collector;
244 negative electrode active material layer;
260 structure;
350 electrolyte;
400 current collector;
420 support layer;
422 first planer surface;
424 second planer surface;
426 side surface;
442 electrically conductive layer;
444 electrically conductive layer;
500 current collector;
522 through-hole;
546 electrically conductive material;
600 current collector;
620 through-hole;
622 inner wall portion;
642 electrically conductive layer;
760 stack structure;
820 positive electrode connection;
822 lead;
824 sub-lead;
840 negative electrode connection;
842 lead;
844 sub-lead;
1102 current collector;
1104 current collector;
1120 welding device;
1130 welding head;
1132 position adjustment unit;
1134 heating unit;
1136 welding unit;
1140 heating power supply;
1150 welding power supply;
1160 controller;
1522 metal material;
1524 resin material;
1526 void.

What is claimed is:

1. A stack comprising a plurality of sheet materials that are stacked, wherein each of the plurality of sheet materials has:
a support layer including a thermoplastic resin material; and
a first metal layer and a second metal layer formed on both faces of the support layer,
in a part of the plurality of sheet materials, a plurality of first metal layers, each of which is identical to the first metal layer, and a plurality of second metal layers, each of which is identical to the second metal layer, included in the plurality of sheet materials are integrated by welding,
each of the plurality of sheet materials has a region in which a plurality of through-holes extending through each sheet material are formed in a vicinity of an integrated region, which is a region in which the plurality of first metal layers and the plurality of second metal layers are integrated by welding,
a circular equivalent diameter of the plurality of through-holes is from 15 μm to 150 μm, and
an interval of two adjacent through-holes among the plurality of through-holes is from 30 μm to 250 μm.

2. The stack according to claim 1, wherein a ratio of a volume of resin included in the integrated region to a volume of metal included in the integrated region is from 5 to 50%.

3. The stack according to claim 2, wherein the plurality of sheet materials has:
a first sheet material arranged at an outermost part on one side of the plurality of sheet materials,
the stack further includes:
a first support member with electrical conductivity supporting the first sheet material,
a main component of the first support member is different from a main component of the plurality of first metal layers and a main component of the plurality of second metal layers, and
in the integrated region, a ratio of a volume of the thermoplastic resin material to a total of a volume of a metal of a same type as the main component of the plurality of first metal layers and a volume of a metal of a same type as the main component of the plurality of second metal layers is from 5 to 50%.

4. The stack according to claim 1, wherein a ratio of a volume of voids included in the integrated region to a volume of metal included in the integrated region is 10% or less.

5. The stack according to claim 1, wherein the plurality of sheet materials has:
a first sheet material arranged at an outermost part on one side of the plurality of sheet materials, and
a second sheet material arranged at an outermost part on another side of the plurality of sheet materials, and
the stack further includes:
a first support member with electrical conductivity supporting the first sheet material; and
a second support member with electrical conductivity or non-electrical conductivity supporting the second sheet material.

6. The stack according to claim 1, further comprising an electrically conductive layer arranged on an inner walls of at least a part of the plurality of through-holes.

7. The stack according to claim 6, wherein the electrically conductive layer has three or more layers with different main components.

8. The stack according to claim 1, wherein the thermoplastic resin material is arranged inside at least part of the plurality of through-holes.

9. The stack according to claim 1, wherein, in each of the plurality of sheet materials,
(a) a first ratio that is a ratio of a volume of the thermoplastic resin material included in the integrated region to a volume of metal included in the integrated region is lower than (b) a second ratio that is a ratio of a volume of thermoplastic resin material to a volume of metal at a position 5 mm or more away from an end of the integrated region of a third sheet material included in the plurality of sheet materials, and
the third sheet material is a sheet material where the second ratio is highest among the plurality of sheet materials.

10. The stack according to claim 9, wherein a value of the first ratio is 0.1 to 0.7 times a value of the second ratio.

11. An electrode structure comprising:
a first electrode and a second electrode;
a third electrode and a fourth electrode; and
a first separator, a second separator, and a third separator,
wherein the first electrode, the first separator, the third electrode, the second separator, the second electrode, the third separator, and the fourth electrode are stacked in this sequence,
each of the first electrode and the second electrode has:
a current collector; and
an active material layer arranged on at least one face of the current collector,
the current collector includes:
a support layer including a thermoplastic resin material; and
a first metal layer and a second metal layer formed on both faces of the support layer,
in a vicinity of an end of the first electrode and the second electrode, the first metal layer and the second metal layer of the first electrode as well as the first metal layer and the second metal layer of the second electrode are integrated by welding,
the current collector has a region in which a plurality of through-holes extending through the current collector are formed in a vicinity of an integrated region, which is a region in which the first metal layer and the second metal layer are integrated by welding,
a circular equivalent diameter of the plurality of through-holes is from 15 μm to 150 μm, and
an interval of two adjacent through-holes among the plurality of through-holes is from 30 μm to 250 μm.

12. The electrode structure according to claim 11, wherein (a) a first ratio that is a ratio of a volume of the thermoplastic resin material included in the integrated region to a volume of metal included in the integrated region is lower than (b) a second ratio that is a ratio of a volume of a thermoplastic resin material to a volume of metal at a position 5 mm or more away from an end of the integrated region of the current collector included in the first electrode or the second electrode, and
the second ratio is the ratio in the current collector in which the ratio is higher among the current collector of the first electrode and the current collector of the second electrode.

13. A battery comprising:
the electrode structure according to claim 12; and
a housing that accommodates the electrode structure.

14. A flight vehicle comprising:
the battery according to claim 13; and
a propulsive force generator that generates propulsive force using electrical energy accumulated in the battery.

15. A method for producing a stack, comprising:
preparing a welding target including a support layer including a thermoplastic resin material as well as a first metal layer and a second metal layer formed on both faces of the support layer;
stacking a plurality of welding targets, each of which is identical to the welding target;
softening the resin material of a softened region arranged in a part of the plurality of welding targets by applying energy to the softened region;
pressing a welded region arranged in at least a part of the softened region; and
welding the first metal layer and the second metal layer of the plurality of welding targets by applying current and/or voltage to the welded region, which has been pressed,
wherein the first metal layer and the second metal layer of each of the plurality of welding targets are electrically connected,
a plurality of through-holes extending through the support layer, the first metal layer, and the second metal layer are formed in at least a part of the softened region of each of the plurality of welding targets,
a circular equivalent diameter of the plurality of through-holes is from 15 μm to 150 μm,
an interval of two adjacent through-holes among the plurality of through-holes is from 30 μm to 250 μm, and
the pressing includes:
applying pressure to the plurality of welding targets that have undergone the stacking so that the resin material that has undergone the softening flows into at least a part of through-holes; and
bringing the first metal layer and the second metal layer of each of the plurality of welding targets close to each other to a distance that allows welding.

16. The method for producing a stack according to claim 15, wherein an electrically conductive member that electrically connects the first metal layer and the second metal layer is arranged on inner walls of at least a part of the plurality of through-holes.

17. The method for producing a stack according to claim 16, wherein the electrically conductive member includes a plurality of layers, and
each of the plurality of layers is constituted of a material different from each other.

18. The method for producing a stack according to claim 15, wherein a plurality of through-holes extending through the support layer, the first metal layer, and the second metal layer are formed in the welded region of each of the plurality of welding targets, and
a plurality of through-holes extending through the first metal layer and the second metal layer are formed in a region adjacent to the welded region of the softened region of each of the plurality of welding targets.

19. The method for producing a stack according to claim 15, wherein an electrically conductive member that electrically connects the first metal layer and the second metal layer is arranged on inner walls of at least a part of the plurality of through-holes, and
the applying pressure to the plurality of welding targets includes:
applying pressure to the plurality of welding targets that have undergone the stacking, so that the resin material that has undergone the softening fractures the electrically conductive member arranged on the inner walls of the at least a part of the through-holes and flows into the at least a part of the through-holes.

20. The method for producing a stack according to claim 15, wherein the welding includes applying current and/or voltage to the welded region while further pressing the welded region pressed in the pressing.

21. The method for producing a stack according to claim 15, further comprising supporting the softened region or the welded region of the plurality of welding targets by sandwiching it using a first support member with electrical conductivity and a second support member with electrical conductivity or non-electrical conductivity,
wherein the supporting is performed before the softening or the pressing.

22. A method for producing an electrode structure, comprising preparing a first electrode and a second electrode;
preparing a third electrode and a fourth electrode;
preparing a first separator, a second separator, and a third separator;
stacking the first electrode, the first separator, the third electrode, the second separator, the second electrode, the third separator, and the fourth electrode in this sequence; and
welding a part of the first electrode and the second electrode,
wherein each of the first electrode and the second electrode includes:
a current collector; and
an active material layer arranged on at least one face of the current collector,
the current collector includes:
a support layer including a thermoplastic resin material; and
a first metal layer and a second metal layer formed on both faces of the support layer,
the first metal layer and the second metal layer are electrically connected,
a plurality of through-holes extending through the support layer, the first metal layer, and the second metal layer are formed in at least a part of a softened region arranged in a part of the current collector,
a circular equivalent diameter of the plurality of through-holes is from 15 μm to 150 μm,
an interval of two adjacent through-holes among the plurality of through-holes is from 30 μm to 250 μm,
the welding a part of the first electrode and the second electrode includes:
stacking the current collector of the first electrode and the current collector of the second electrode;
softening the resin material of the softened region by applying energy to the softened region of the current collector;
pressing a welded region arranged in at least a part of the softened region; and
welding the first metal layer and the second metal layer of the current collector of each of the first electrode and the second electrode by applying current and/or voltage to the welded region that has been pressed, and
the pressing includes:
applying pressure to current collectors that have undergone the stacking, each of which is identical to the current collector, such that the resin material that has undergone the softening flows into at least a part of a through-hole; and
bringing the first metal layer and the second metal layer of each of the current collectors that have undergone the stacking close to each other to a distance that allows welding.
